(19) United States
(12) Patent Application Publication
(10) Pub. No.: US 2024/0060598 A1
(43) Pub. Date: Feb. 22, 2024

(54) ROOF ATTACHMENT WITH INTEGRATED SEALANT

(71) Applicant: Pegasus Solar, Inc., Richmond, CA (US)

(72) Inventors: Ian Wogan, Richmond, CA (US); Erich Kai Stephan, Richmond, CA (US)

(21) Appl. No.: 18/236,353

(22) Filed: Aug. 21, 2023

Related U.S. Application Data
(60) Provisional application No. 63/399,603, filed on Aug. 19, 2022.

(51) Int. Cl. F16M 13/02

(52) U.S. Cl. CPC F16M 13/02

(57) ABSTRACT

Apparatuses for roof attachment are provided, as well as methods for assembling and installing roof attachment apparatuses. An exemplary roof attachment apparatus may include a mount and a fastener configured to engage with an installation surface. The fastener may be configured to attach the mount to the installation surface when engaged with the installation surface. The roof attachment apparatus may further include a compressible sealant disposed between a bottom of the mount and the installation surface when the mount is attached to the installation surface. The sealant may thus be compressed based on the engagement between the fastener and the installation surface, and the compressed sealant may flow to fill a volume of space between the bottom of the mount and the installation surface.

### CROSS-REFERENCE TO RELATED APPLICATION

The present application claims the priority benefit of U.S. patent application No. 63/399,603 filed Aug. 19, 2022, the disclosure of which is incorporated by reference herein.

### BACKGROUND OF THE INVENTION

### 1. Field of the Disclosure

The present disclosure is generally related to roof attachments. More specifically, the present disclosure is related to roof attachments with integrated sealant.

### 2. Description of the Related Art

Current roof attachments typically require some method of preventing water intrusion where the roof is penetrated to secure the attachment, such as a hole for a fastener. Often, roof attachments use a sealant or caulking applied during the installation of the roof attachment, a flashing to divert water flow away from roof penetration, or both. The on-roof application of sealant can be time-consuming and messy, and the use of a flashing can be expensive and cause un-intended damage. The present invention demonstrates a cleaner, faster, and more cost-effective way to secure and seal a roof attachment to a roof surface.

### SUMMARY OF THE INVENTION

Embodiments of the present invention include apparatuses for roof attachment, as well as methods for assembling and installing roof attachment apparatuses. An exemplary roof attachment apparatus may include a mount and a fastener configured to engage with an installation surface. The fastener may be configured to attach the mount to the installation surface when engaged with the installation surface. The roof attachment apparatus may further include a compressible sealant disposed between a bottom of the mount and the installation surface when the mount is attached to the installation surface. The sealant may thus be compressed based on the engagement between the fastener and the installation surface, and the compressed sealant may flow to fill a volume of space between the bottom of the mount and the installation surface.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be limiting of its scope, the principles herein are described and explained with additional specificity and detail through the use of the accompanying drawings in which:

FIG. 1 depicts an isometric view of an exemplary roof attachment with integrated sealant in an assembled state.

FIG. 2A depicts an isometric view of an exemplary protective cover that may be used in roof attachments with integrated sealant.

FIG. 2B depicts a cross-sectional side view of the protective cover of FIG. 2A.

FIG. 2C depicts a top plan view of the exemplary protective cover of FIG. 2A.

FIG. 3A depicts an isometric view of an exemplary roof attachment with integrated sealant in a pre-installed state.

FIG. 3B depicts a side plan view of the exemplary roof attachment of FIG. 3A in the pre-installed state.

FIG. 3C depicts a bottom plan view of the exemplary roof attachment of FIG. 3A in the pre-installed state.

FIG. 4A depicts a top plan view of an exemplary roof attachment with integrated sealant in an alternative embodiment.

FIG. 4B depicts a side plan view of the exemplary roof attachment of FIG. 4A.

FIG. 4C depicts an isometric view of the exemplary roof attachment of FIG. 4A.

FIG. 4D depicts another isometric view of the exemplary roof attachment of FIG. 4A.

FIG. 5A depicts an exploded view of an exemplary roof attachment with integrated sealant in an unassembled state.

FIG. 5B depicts another exploded view of the exemplary roof attachment of FIG. 5A in an unassembled state.

FIG. 6 depicts a side cut-away view of an exemplary roof attachment in assembled state.

FIGS. 7A-7B depict isometric perpendicular cut-away views of an exemplary roof attachment in an assembled state with sealant omitted for purpose of seeing the interior of the roof attachment.

FIGS. 8A-8E depict various stages of an exemplary installation of a roof attachment onto an installation surface.

FIG. 9A depicts an isometric view of an exemplary roof attachment in assembled state.

FIG. 9B depicts a cut-away view of the exemplary roof attachment of FIG. 9A.

FIG. 9C depicts an isometric view of the exemplary roof attachment of FIG. 9A in an installed state.

FIG. 9D depicts a cut-away view of the exemplary roof attachment of FIG. 9A in an installed state.

FIG. 9E depicts an isometric view of the exemplary roof attachment of FIG. 9A in an installed state where additional roof fasteners have been installed through additional mount fastener apertures and into an installation surface.

FIG. 9F depicts a cut-away view of the exemplary roof attachment of FIG. 9A in an installed state where additional roof fasteners have been installed through additional mount fastener apertures and into an installation surface.

FIG. 9G depicts an isometric view of the exemplary roof attachment of FIG. 9A in an installed state in which a connection mechanism is engaged with a mount of the roof attachment.

FIG. 10A depicts an isometric view of an exemplary roof attachment having a mount and protective cover with a plurality of mount fastener apertures.

FIG. 10B depicts an isometric view of an alternative roof attachment having a mount and protective cover with a plurality of mount fastener apertures.

FIG. 11A depicts an exploded view of an exemplary roof attachment mount having no vertical flange in an unassembled state.

FIG. 11B depicts an isometric view of the roof attachment of FIG. 11A in an assembled state.

FIG. 11C depicts a bottom isometric view of the roof attachment of FIG. 11A in an assembled state.

FIG. 11D depicts a cut-away view of the roof attachment of FIG. 11A in an assembled state.

FIG. 12A depicts an exploded view of an exemplary mount having no vertical flange in an unassembled state.

FIG. 12B depicts a cut-away view of the exemplary mount of FIG. 12A.

FIG. 12C depicts a bottom isometric view of the exemplary mount of FIG. 12A in an installed state.

FIG. 13A depicts an exploded view of an exemplary roof attachment with integrated sealant in an unassembled state.

FIG. 13B depicts an isometric view of the roof attachment of FIG. 13A in an assembled state.

FIG. 13C depicts a cut-away view of the roof attachment of FIG. 13A in an assembled state.

FIG. 14A depicts an exploded view of an exemplary roof attachment with integrated sealant in an unassembled state.

FIG. 14B depicts a cut-away view of the roof attachment of FIG. 14A in an assembled state.

FIG. 14C depicts an isometric view of the roof attachment of FIG. 14A in an assembled state.

FIG. 14D depicts an isometric view of the roof attachment of FIG. 14A in an installed state.

FIG. 15A depicts an exploded view of an exemplary roof attachment with integrated sealant and a plurality of feet in an unassembled state.

FIG. 15B depicts an isometric view of the roof attachment of FIG. 15A in an assembled state.

FIG. 15C depicts a side plan view of the roof attachment of FIG. 15A in an installed state.

FIG. 16A depicts a cut-away view of an exemplary roof attachment in an installed state and used to mount a rail.

FIG. 16B depicts an isometric view of the roof attachment of FIG. 16A.

FIG. 16C depicts another isometric view of the roof attachment of FIG. 16A.

FIG. 17A depicts an isometric view of an exemplary roof attachment having a channel disposed along a length of a mount in an assembled state.

FIG. 17B depicts an isometric cut-away view of the roof attachment of FIG. 17A in a partially installed state.

FIG. 18A depicts an exploded view of an exemplary roof attachment having a mount configured as an enclosable container in an unassembled state.

FIG. 18B depicts a bottom isometric view of the roof attachment of FIG. 18A in an assembled state.

FIG. 18C depicts a cut-away view of the roof attachment of FIG. 18A in an assembled state.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

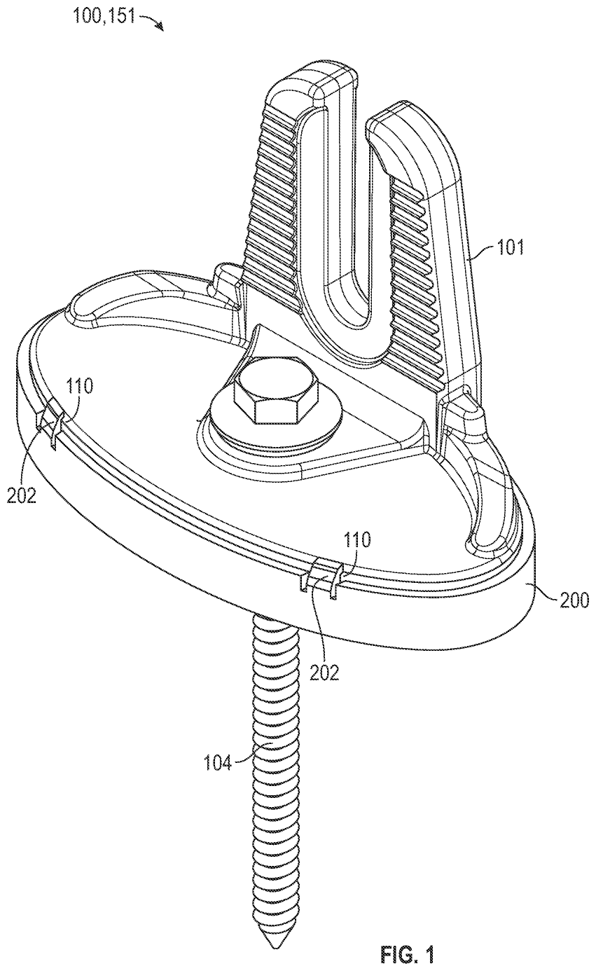

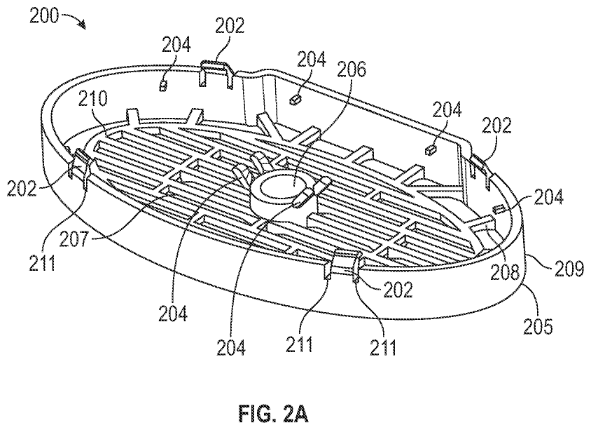

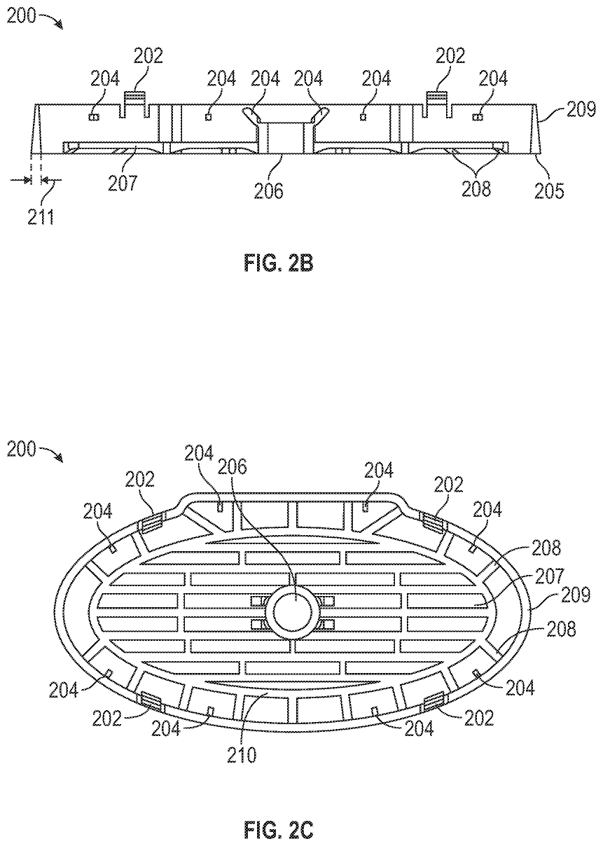

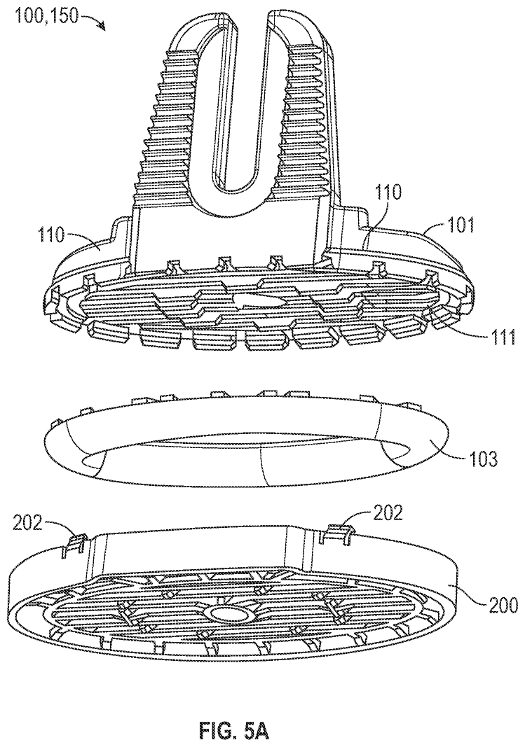

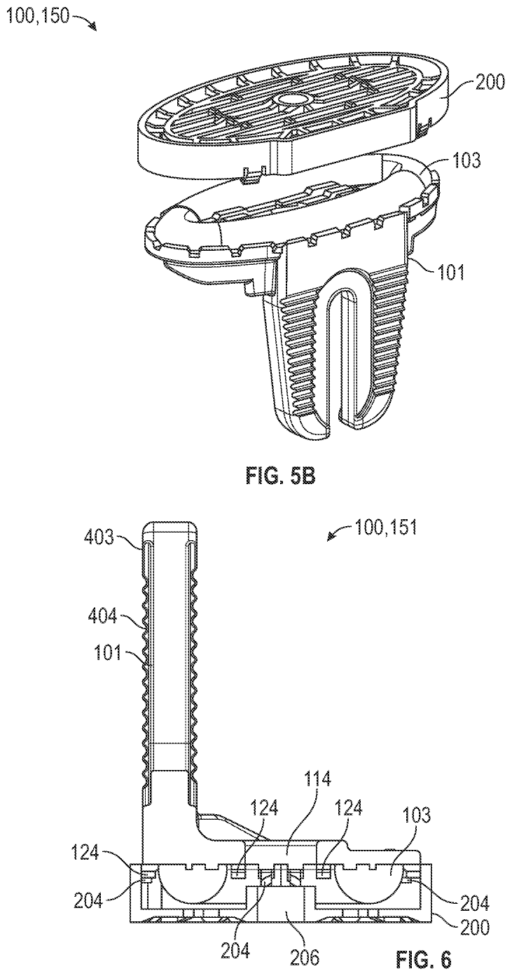

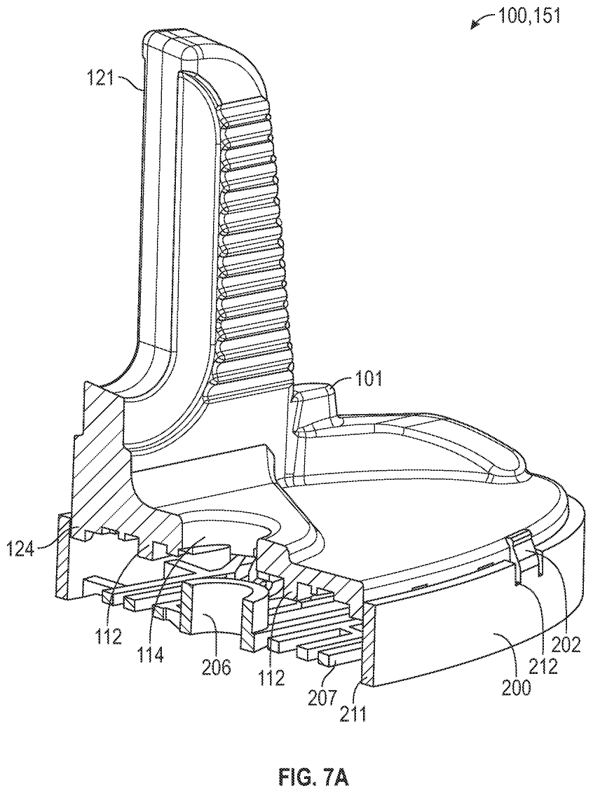

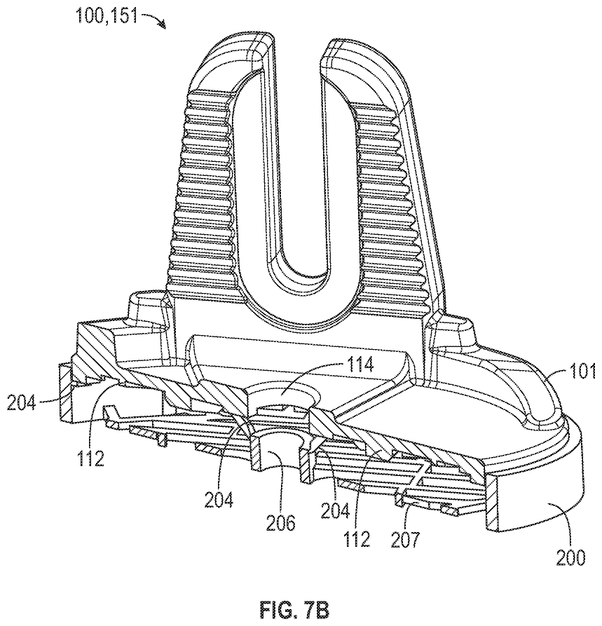

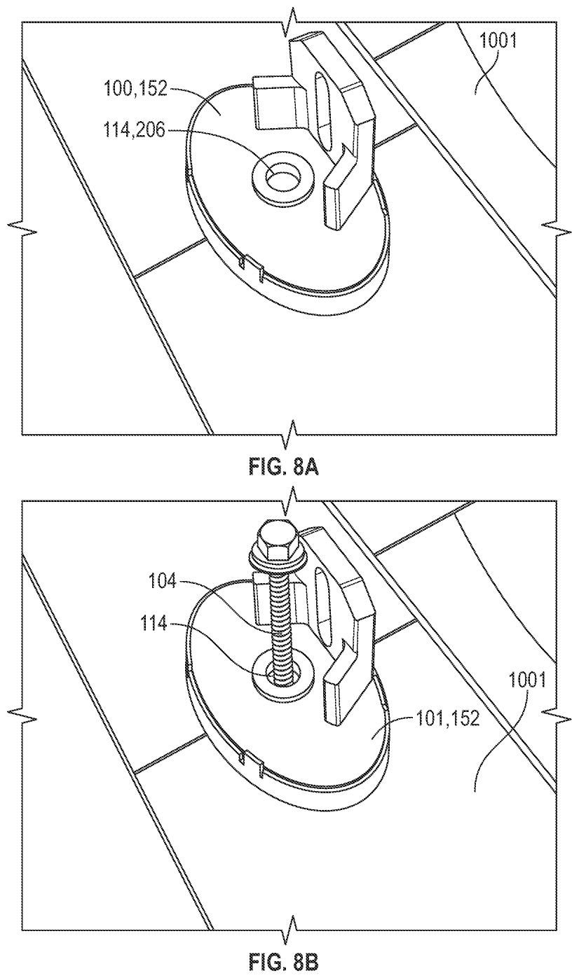

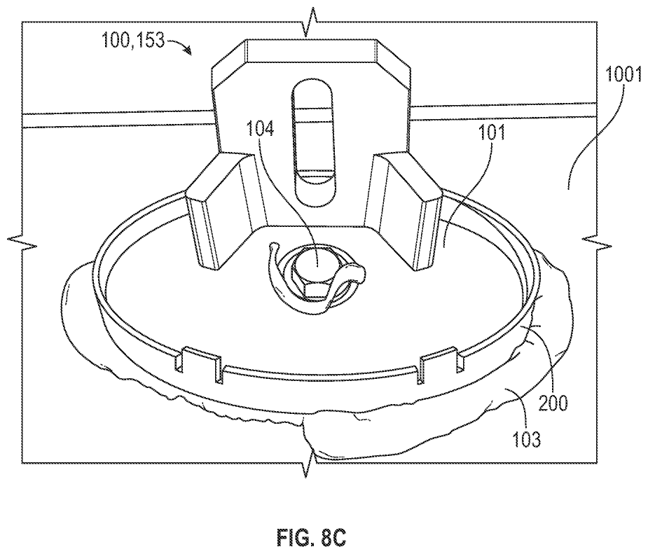

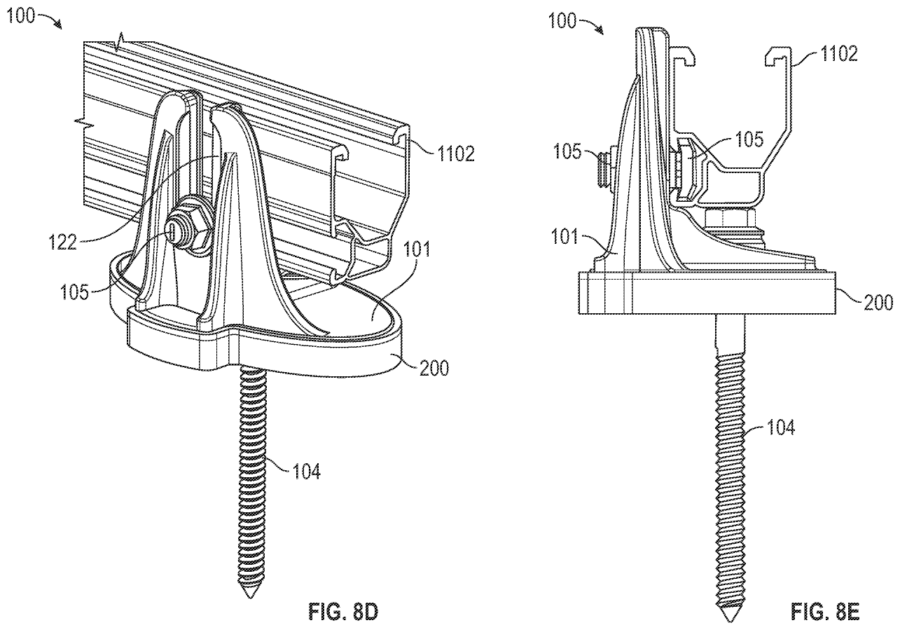

FIG. 1 depicts an isometric view of an exemplary roof attachment 100 with integrated sealant 103 in an assembled state 151. Roof attachment 100 may consist of a mount 101, protective cover 200 (described further in relation to FIGS. 2A-2C), a volume of sealant 103 (illustrated in FIG. 5A), one or more roof fasteners 104, and in some embodiments, one or more connecting mechanisms 105 (illustrated in FIG. 8D). The roof attachment 100 may have several states, such as an unassembled state 150 (illustrated in FIGS. 5A-5B), an assembled state 151 (also illustrated in FIGS. 7A-B), a pre-installed state 152 (illustrated in FIG. 8A), and an installed state 153 (illustrated in FIG. 8C). FIG. 1 depicts the roof attachment 100 in an assembled state 151.

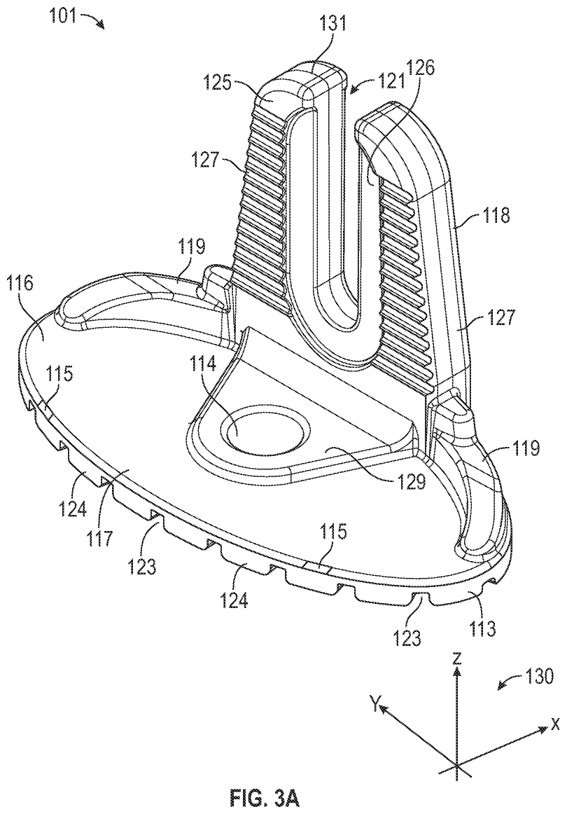

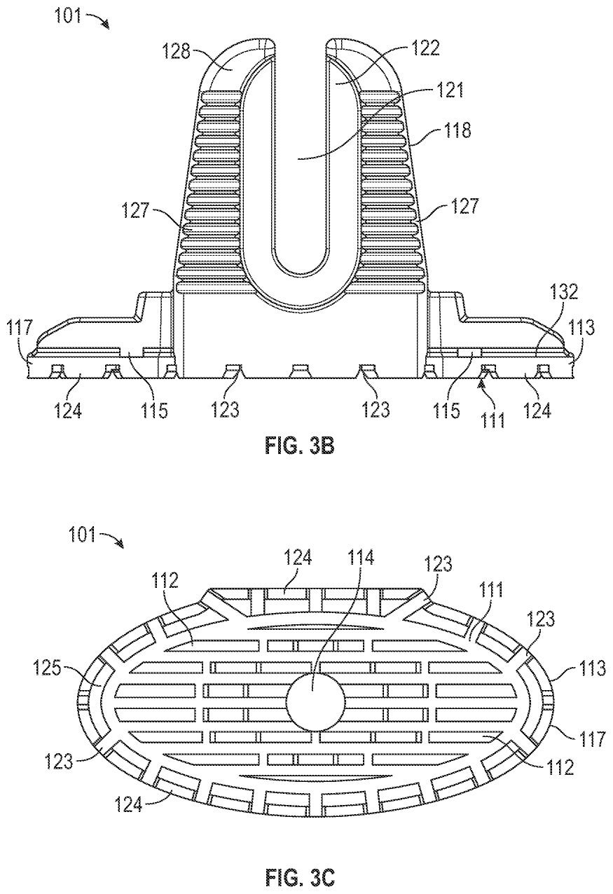

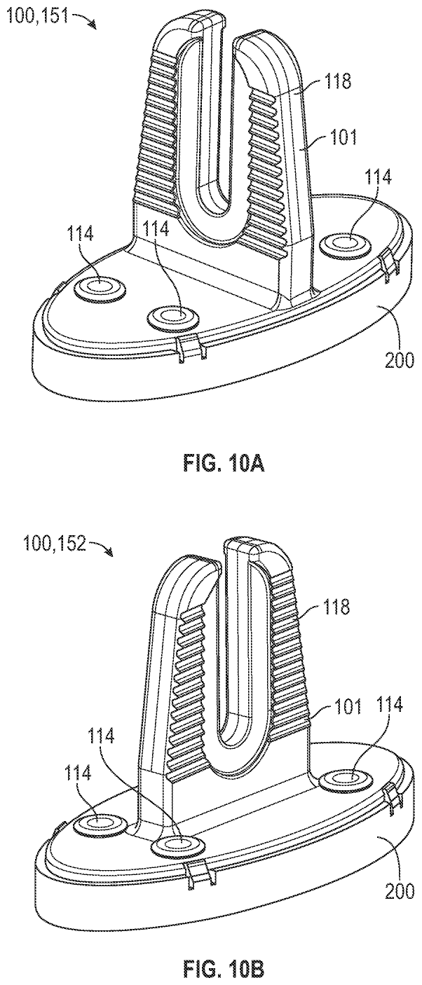

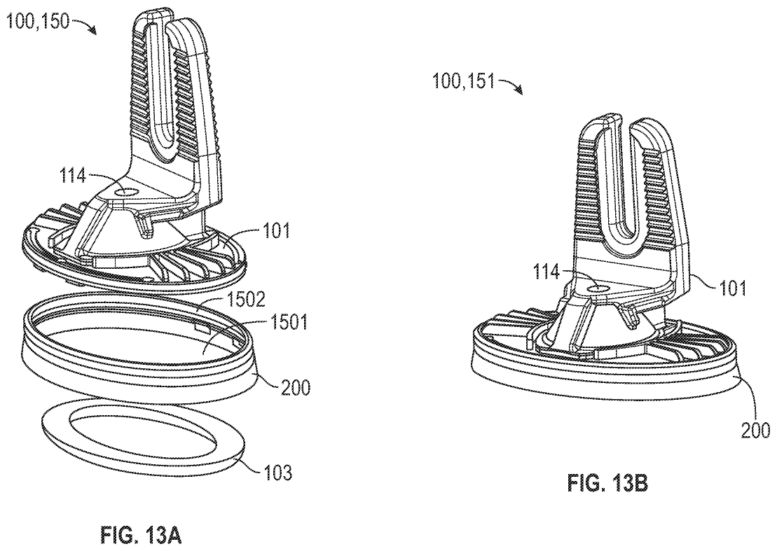

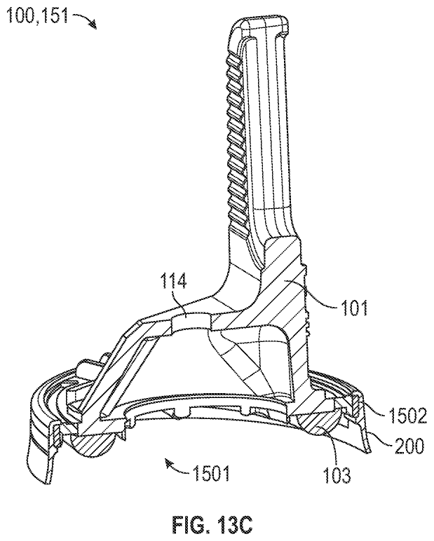

FIGS. 2A through 2C depict a protective cover 200 representing one example of the present invention. FIG. 2A depicts an isometric view of the protective cover 200 that may be used in roof attachments with integrated sealant. As illustrated, protective cover 200 may include a plurality of lock-tabs 202 and stop-tabs 204. Perimeter wall 209 may fully or partially encompass or surround the shape of the protective cover 200, and may be substantially coincident with mount perimeter 113 (illustrated in FIG. 3A). Stop-tabs 204 may take the form of several geometries, such as the stop-tabs 204 shown protruding from the cover fastener aperture 206, or such as the stop-tabs 204 protruding inwards from the perimeter wall 209. A mesh 207, cage, or screen-like plane may be disposed across the bottom of protective cover 200. Mesh 207 may take the form of a grid-like pattern, a honeycomb pattern, or a complex pattern, where various openings or apertures are disposed across mesh 207. In other example embodiments, such as shown in FIG. 13A, a single opening may be formed by the distal edge of perimeter wall 209. The plurality and varying shapes of openings or apertures formed by mesh 207 may be sized to allow sealant 103 to flow through when the roof attachment 100 is transitioned to an installed state 153, yet may be small enough to readily prevent foreign objects, such as a small pebble or human finger, from passing through. The mesh pattern may take a form to allow a plurality of mount feet 112 (illustrated in FIG. 3C) to pass through openings in the mesh 207 in order to make direct contact with an installation surface 1001 (illustrated in FIG. 10A).

Protective cover 200 may have one or more stop-tabs 204 that are positioned to abut mount 101 (illustrated in FIG. 1) when the lock-tabs 202 are substantially engaged with a lock feature 115 (illustrated in FIG. 3A). In other example embodiments, one or more lock-tabs 202 simply engage with the top surface 116 (illustrated in FIG. 3A) of mount 101. The one or more stop-tabs 204 may also abut with the mount 101, such as on the underside surface 111 (illustrated in FIG. 3B) or one or more mount feet 112, or on one or more of the perimeter feet 124 (illustrated in FIG. 3A), to prevent the protective cover 200 from traversing further onto mount 101. Protective cover 200 may have a geometry such that one or more stop-tabs 204 prevent all or a portion of mesh 207 from touching the sealant 103. Likewise, the thickness of the sealant 103, as measured as the distance away from the underside surface 111, may have a height such that the sealant 103 does not extend below the bottom exterior edge 205, or contact mesh 207 or beyond one or more flanges, feet, or similar features on the protective cover 200 when the stop-tabs 204 abut the underside surface 111, typically in an assembled state 151.

One or more stop-tabs 204 may be flexible resilient members, substantially re-forming to their original state after mount 101 has traversed through the protective cover 200 until contacting an installation surface 1001. In another example embodiment, stop-tabs 204 may break, snap, yield, dislodge, or permanently bend after mount 101 traverses through protective cover 200 until contacting an installation surface 1001. Stop-tabs 204 may have enough strength to prevent the protective cover 200 from flexing or traversing up the mount 101 such that the sealant 103 coincides with the mesh 207 while one or more roof attachments 100 are being transported to a final installation site. In other words, stop-tabs 204 may have enough tensile strength or sufficient elongation properties to withstand the weight of not only mount 101, but also several roof attachments 100 that may be stacked on top, e.g., in packaging and shipping to a final installation location. Stop-tabs 204 may have a maximum yield or tensile strength or sufficient elongation properties such that they bend, break, deflect, or otherwise allow mount 101 to traverse through the protective cover 200 upon one or more roof fasteners 104 engaging an installation surface 1001 and compressing the mount 101 onto the installation surface 1001.

FIG. 2B depicts a cross-sectional side view of protective cover 200 representing one example embodiment of the present invention. As depicted, mesh 207 may have all or a portion of its bottom surface offset from the bottom exterior edge 205. The offset distance may be a sufficient distance to allow sealant 103 to traverse across installation surface 1001 and under mesh 207 when the roof attachment 100 transitions to an installed state 153. Perimeter wall 209 may have a variable-thickness cross-section 211 where the exterior surface and interior surface are not parallel with one another. In other words, the thickness of perimeter wall 209 may be thinner near a distal end compared to a thickness at a mid-height or compared to the opposite distal end of the cross-section 211, as shown. Perimeter wall 209 may have a thickness less than the diameter of typical pilot hole for the roof fastener 104.

FIG. 2C depicts a top-down view of a protective cover 200, representing one example embodiment of the present invention. As depicted, a mesh perimeter 210 substantially matches the shape of perimeter wall 209 and may be connected to perimeter wall 209 by one or more ribs 208. Mesh 207 may be disposed across mesh perimeter 210. One or more cover fastener apertures 206 may be disposed throughout the mesh 207 in a position that is substantially concentric with a mount fastener aperture 114 (illustrated in FIG. 3A) when the roof attachment 100 is in an assembled state 151. Mesh 207 may be configured to cooperate with the mount feet 112 or any protrusions on the underside surface 111 such that mesh 207 partially or fully nests within the protrusions when roof attachment 100 is in an installed state 153.

Protective cover 200 may be made from a polymer, EPDM rubber, silicon, other rubber, injection molded plastic, a cast metal, such as aluminum, carbon or stainless steel, foam, or another suitable material. Protective cover 200 may have no additional coatings, or it may have a coating, such as a paint.

FIGS. 3A-3C depict mount 101 in an isometric, side, and underside view representing one example of the present invention. FIG. 3A depicts an example mount 101 in an isometric view consisting of a base 117, vertical flange 118, one or more flange ribs 119, one or more mount fastener apertures 114, a flange aperture 121, a front recess 126, a rear recess 122 (illustrated in FIG. 3B), and a plurality of notches 123 around the lower edge perimeter of the mount 101. On the underside around the perimeter of mount 101, one or more notches 123 may form one or more perimeter feet 124 that substantially follow the exterior contour of mount 101, as seen in FIG. 3C. Notches 123 forming the perimeter feet 124 may have the same cross-sectional width as viewed from FIG. 3B, or may have varying widths. As seen from the side, one or more of the notches 123 may have a tapered geometry, wherein the width of the notch narrows towards the underside surface 111. Interior to the perimeter feet 124, a plurality of protruding mount feet 112 may be disposed. Mount feet 112 may extend from the underside surface 111 until substantially coincident with the bottom surface of the perimeter feet 124, or they may extend down from the underside surface 111 less than the distance that the perimeter feet 124 extend down from the underside surface 111. Perimeter feet 124 may have an addition, shorter step 133 adjacent towards the interior of mount 101, as shown in FIG. 3C.

On the top edge of base 117, one or more lock features 115 may be formed to cooperate with the lock-tabs 202. Lock features 115 may be a chamfered corner on one or more portions of the base 117, or around the entire perimeter of the base 117. Alternatively, the lock feature 115 may be a radius, step, lip, groove, flange, recess, or other geometry designed to cooperate with one or more lock-tabs 202. When the perimeter feet 124 are on a flat plane, such as an installation surface 1001, the first flange face 125 and the rear recess 122 may be perpendicular to the plane. The top surface 116 may form a non-perpendicular angle with the plane, and therefore a non-perpendicular angle with the first flange face 125. As seen in FIG. 3A, flange sides 127 may have a parting line along their length such that a first portion of the flange sides 127 forms an acute angle with the first flange face 125, and a second portion of the side face forms an acute angle with second flange face 128 (illustrated in FIG. 3B). One or more flange ribs 119 may extend from vertical flange 118 in either the Y, X or both directions, in a linear or a curved shape, as shown in FIG. 3A. Flange ribs 119 may be solid or hollow. In example embodiments where flange ribs 119 extend towards the mount fastener aperture 114, such flange ribs 119 may have a truncated height that is tangent or lower than the bottom point of the flange aperture 121. In this way, a rail 1102 (illustrated in FIG. 8E) may be installed against a first flange face 125 without interfering with the flange ribs 119 when a connection mechanism 105 is in a lowest position in flange aperture 121.

Base 117 may have one or more mount fastener apertures 114 configured to receive one or more roof fasteners 104. Mount fastener apertures 114 may be circular in shape, or slotted in shape. Mount fastener apertures 114 may have vertical walls, or they may have tapered walls, wherein a first end and second end of the mount fastener aperture 114 has a different width or diameter. The one or more mount fastener apertures 114 may be formed with an elevated section 129 protruding up from the top surface 116, wherein the top surface of the elevated section 129 may be parallel with the top surface 116, or at an angle relative to the top surface 116. Elevated section 129 may have a profile that is substantially the same outlined shape as one or more mount fastener apertures 114, e.g., a circle, or elevated section 129 may extend in a tapered shaped toward the vertical flange 118 as depicted in FIG. 3A. In some example embodiments, a thin web of material may be disposed across one or more mount fastener apertures 114. The tip of a roof fastener 104 may be configured to drill, cut, or pierce through the thin web in order to traverse through a mount fastener aperture 114 and reach an installation surface. The thin web may be formed of the same material as mount 101, such as die cast aluminum formed when manufacturing mount 101, or it may be a different material, such as a rubber or plastic, installed after mount 101 is manufactured.

In FIG. 3A, a parting line plane 131 may be formed along the Y and Z Axis in the depicted coordinate plane 130. The parting line plane 131 may be positioned along the X axis to bisect the vertical flange 118, either in its mid-point or offset to one side of the vertical flange 118. In one example of the present invention, substantially all flat surfaces above the base 117 may form either an obtuse angle, or be parallel, with the parting line plane 131 in order to aid in the manufacturability of the part using a mold, such as in a cast part. In another example of the present invention, the parting line plane 131 may be defined by the Y axis and an angle relative to a Y-Z axis plane (e.g., the plane is rotated about the Y-axis) so that the top surface 116 may be at an obtuse angle with the parting line plane 131 while also parallel with the underside surface 111. In FIG. 3B, a slide plane 132 may be defined by the X and Y axis and may be located along the Z axis with a portion of the slide plane 132 coincident with the underside surface 111. Surfaces in the negative Z direction from the slide plane 132 may form either an obtuse angle with the slide plane 132, such as the side surfaces of the mount feet 112 and perimeter feet 124, or may be substantially parallel with the slide plane 132, such as the bottom surface of the mount feet 112.

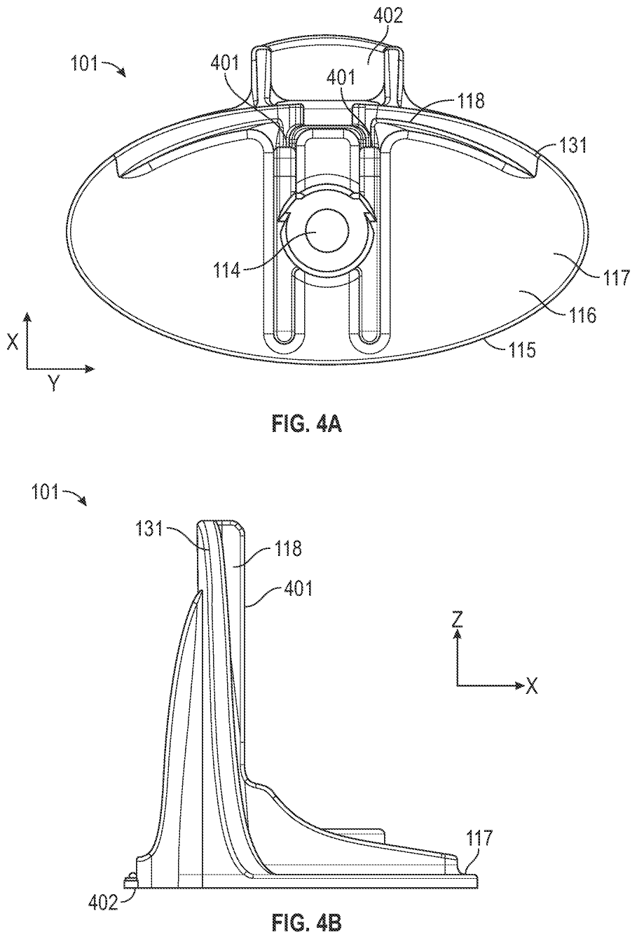

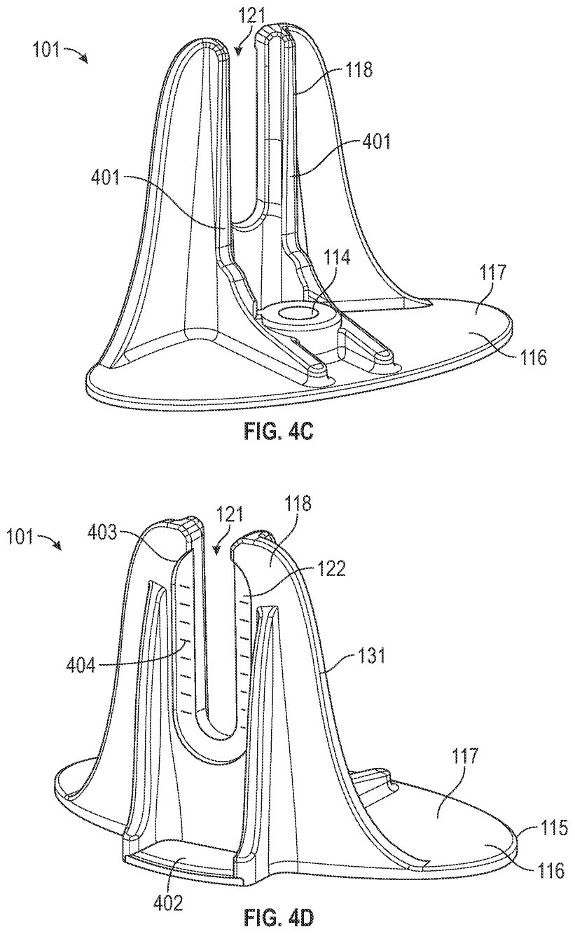

FIGS. 4A through 4D depict an alternative embodiment of the mount 101, representing another example of the present invention. In this example embodiment, the vertical flange 118 may have a curved shape as seen from above in FIG. 4A. One or more protrusions from the vertical flange 118 on either side of the flange aperture 121 (illustrated in FIG. 4C) may provide a flat connection surface 401 to mount 101 a connection mechanism 105. The parting line plane 131 may be formed along a tangent to the outside curve of the vertical flange 118, or the parting line plane 131 may be curved substantially following the curve of the vertical flange 118. Alternatively, the parting line plane 131 may be parallel to the top surface 116 of the base 117, or at a slight angle to the base 117, so the wall surfaces of the vertical flange 118 form an obtuse angle with the parting line plane 131. The parting line plane 131 may be at a slight angle to the top surface 116 of the base 117 in order to allow for the flat connection surface 401 to be substantially perpendicular to the bottom of the mount 101 so that the flat connection surface 401 is perpendicular to an installation surface 1001 upon installation.

Base 117 may have a larger dimension in the Y direction compared to the X direction. Base 117 may have an oval shape, as shown, or may have a rectangular shape, polygon shape, or a complex shape. As viewed from above, mount 101 may also have one or more base flanges 402 that extend beyond the perimeter of an oval shape, to make a complex shape and provide additional structural support.

The flange aperture 121 may be formed through vertical flange 118, and may be a circular hole, a slotted hole closed on both ends of the slot, or a slotted hole with one end open to the top of vertical flange 118, as shown in FIG. 4C. Vertical flange 118 may be configured to receive a connection mechanism 105 to secure a rail 1102 or a solar energy panel to roof attachment 100. In FIG. 4D, flange aperture 121 may have a rear recess 122, wherein the recessed surface forms a perimeter lip 403. Rear recess 122 may be configured to allow the flange of a nut on a connection mechanism 105 to reside within rear recess 122, such that the flange of the nut may abut perimeter lip 403 to prevent the nut from readily sliding out of the flange aperture 121 in the positive Z direction. Rear recess 122 may have serrations 404 disposed on its surface to cooperate with and prevent a connection mechanism 105 from readily decoupling from roof attachment 100. In some embodiments, serrations 404 may also be present on a front recess 126.

The one or more fastener apertures 114 may have a tapered cross section, wherein the diameter of the fastener aperture 114 on the top side of base 117 is different from the diameter of the fastener apertures 114 on the underside surface 111.

Mount 101 may be manufactured from a variety of techniques using a variety of materials, such as high pressure die casting, investment casting, vacuum die casting, injection molding, extrusion, machining, turning, forging, additive manufacturing methods, or other suitable techniques. Mount 101 may be made from aluminum, steel, stainless steel, polymers, plastics, resins, glass-reinforced resins, carbon-reinforced resins, or other suitable materials.

FIGS. 5A-B depict an embodiment of the present invention wherein sealant 103 has been disposed onto the underside surface 111 of mount 101, and the protective cover 200 is aligned with mount 101. Sealant 103 may be pre-formed into a configuration such as an oval, as shown, or it may be disposed onto the underside surface 111 in the desired shape, such as when injected from a nozzle. In an example assembly process, roof attachment 100 may begin in an unassembled state 150 where mount 101, protective cover 200, sealant 103, and one or more roof fasteners 104 are loose, unassembled, and unassociated components. In some embodiments, these components may come from a variety of different manufacturing suppliers or sources. In transforming roof attachment 100 from an unassembled state 150 to an assembled state 151, mount 101 may be placed in a fixture, including a stationary or a robotic assembly line-type fixture. Mount 101 may be positioned upside down, wherein the underside of the mount 101 is facing substantially upward as in FIG. 5B. Then, sealant 103 may be disposed onto the underside surface 111 in one or more circular, ovoid, square, polygon, line, dot, dollop or other similar shapes or patterns. Sealant 103 may have a prescribed volume disposed on the underside surface 111, controlled for example by an electronic dispenser. In another application process, sealant 103 may be disposed using a manual process, such as using a caulking tube or syringe. Sealant 103 may be disposed to form a substantially desired, or programmed, shape, thickness, width, or curvature, to achieve a desired volume. In an alternative process, sealant 103 may instead be disposed into the protective cover 200, such as on the mesh 207, in one or more circular, ovoid, square, polygon, line, dot, dollop or other similar shapes or patterns.

In a potential next step, protective cover 200 may be aligned over the underside of mount 101. Alternatively, protective cover 200 may be in a fixed position and mount 101 with applied sealant 103 may be positioned to align over the protective cover 200. Protective cover 200 then may be pressed onto mount 101 such that one or more lock-tabs 202 engage and/or cooperate with a lip, groove, flange, chamfer, radius, or similar engagement feature 110 on mount 101 to prevent the protective cover 200 from readily de-coupling off the mount 101 in a reverse direction after engagement.

FIG. 6 depicts a side cut-away view of roof attachment 100 in assembled state 151. In the assembled state 151, sealant 103 has been applied to the underside of mount 101, and the protective cover 200 has been installed onto mount 101 such that lock-tabs 202 have engaged with one or more engagement features 110, and stop-tabs 204 have or are nearly abut with mount 101. As an example, an intentional tolerance may be allowed for a gap to remain between mount 101 and stop-tabs 204 when lock-tabs 202 engage, or alternatively, an intentional interference-fit may occur between the stop-tabs 204 and mount 101 when the lock-tabs 202 engage with one or more engagement features 110. As depicted in FIG. 6, sealant 103 is in an initial (un-compressed) state, where it may form a dome-like shape when viewed in a cross-section. In this un-compressed state, sealant 103 may have a tapered shape such that a thinner cross-section is near the lower edge (e.g., furthest from underside surface 111) and a wider cross-section near underside surface 111. The cross-sectional shape of sealant 103 may be a substantially shaped sideways “D”, a trapezoid, pyramid, ovoid, circular, half-ovoid, half-circular, or similar shape. Sealant 103 may have an initial shape or a width in the pre-installed state 152, that upon mount 101 being compressed onto the installation surface 1001 as the roof attachment 100 transitions to an installed state 153 (e.g., having a different shape corresponding to the volume of space that the compressed sealant 103 has filled), sufficient pressure is induced onto sealant 103 to allow the mount 101 to contact the installation surface 1001 and the sealant 103 to flow substantially throughout the projected area of the foot, and in some embodiments, beyond the perimeter wall 209 of the protective cover 200. In other embodiments, a reservoir space may be defined in protective cover wherein excess sealant 103 is directed into the reservoir space upon roof attachment 100 transitioning to an installed state 153.

Sealant 103 consists of a substance meant to prevent water from accessing a roof penetration where a roof fastener 104 is located to secure roof attachment 100 to a installation surface 1001. Additionally, sealant 103 may have characteristics to fill voids or cracks on the underlying installation surface 1001, such as a gap between asphalt shingles, or to fill vacant holes in the roof such as unused pilot holes. Sealant 103 may have properties of being waterproof, water resistant, weatherproof, or to repel water. In example embodiments of the present invention, sealant 103 may be an isobutylene compound, a butyl-based rubber sealant, a wax, a non-skinning or minimally skinning sealant, a non-sag or minimally-sag sealant, or a combination thereof.

Sealant 103 may have a defined viscosity or ingress protection rating to prevent sealant 103 from readily flowing beyond protective cover 200 when roof attachment 100 is in any orientation (such as right side up, upside-down, sideways, or in a bulk packed package) in elevated temperatures, such as 140 degrees Fahrenheit, while also having a viscosity that still allows sealant 103 to deform from an initial shape and to move to different locations or positions under pressure so as to fill spaces of different shapes (e.g., around a roof fastener 104 or through mesh 207 or into voids in the roof) when installed in colder climates as well, such as when installing on a sub-freezing roof top.

In some embodiments, sealant 103 may have properties of being permanently or semi-permanently flexible or flowable, maintain a permanent or semi-permanent surface tack, be self-healing, or a combination thereof. In another example embodiment of the present invention, sealant 103 may be formulated for a desired time period, such as 6 months, 1-year, etc., to maintain a desired flexibility or flowability, maintain a surface tack, be self-healing, or a combination thereof. Sealant 103 may maintain flexibility or flowability at low temperatures and may be designed to perform in its intended use, transitioning from a pre-installed state 152 to installed state 153 (e.g., different shapes and positions within the roof attachment 101) in temperatures ranging from 0 degrees to 180 degrees Fahrenheit.

Sealant 103 may have a specific color, such as off-white, dark gray, or blue, such as for the purpose of visually blending into the average hues and colors of the installation surface 1001, or visually contrasting with the average hues and/or colors of the installation surface 1001 or a protective cover 200. Alternatively, sealant 103 may intentionally have a color that contrasts with the color of the protective cover 200 and or installation surface 1001 in order to readily provide visual confirmation of mount 101 transitioning between a pre-installed state 152 to installed state 153 if sealant 103 ejects outside of the perimeter, edge, or surface of protective cover 200 or mount 101, or into a reservoir, such that a portion of sealant 103 is visible to the person installing roof attachment 100.

Sealant 103 may be non-hardening, defined as maintaining a liquid or semi-liquid state for a prolonged period of time, such as 6-months, 1-year, or 10-years, or indefinitely. Sealant 103 may have a low viscosity, or have a cure time greater than 1, 5, or 10 years. Sealant 103 may have an asymptomatic cure time, wherein it hardens over time but never fully hardens or cures. In other words, sealant 103 may increase in viscosity, decrease in flexibility, decrease in tack, decrease in adhesion, or change state, or a combination thereof over time. Sealant 103 may remain tacky for an extended period of time, such as 10 or 30 years, such that sealant 103 maintains a water-resistant barrier with the installation surface 1001. Some formulations of sealant 103 may or may not retain resilience following compression and thus may not be capable of transitioning from an installed state 153 back to an uninstalled state (e.g., unassembled state 150).

Sealant 103 may have a chemistry to be compatible with a variety of roofing materials, such as asphalt, composite asphalt, composite shingle, tar paper, roofing paper, tar roof, thermoplastic polyolefin (TPO), polyvinyl chloride (PVC), Hypalon, Kynar, painted metal, fiberglass, stone-coated steel, clay, ceramic, glass, concrete, cement, and other common roofing materials. Sealant 103 may reduce in viscosity at temperatures above the room temperature, with one purpose being to more readily disperse a bead of sealant 103 onto the underside of mount 101 during assembly, e.g., when transitioning the roof attachment 100 from an unassembled state 150 to an assembled state 151. Sealant 103 may have a viscosity in a standard installation temperature range, such as from 0 degrees to 170 degrees Fahrenheit, that allows the sealant 103 to flow into and wet substantially all surfaces of an installation surface underneath mount 101 when roof attachment 100 is in an installed state 153. Installation surface 1001 may be one or more asphalt shingle tabs, where the tabs abut together with a thin gap between the tabs. The viscosity of sealant 103 may allow sealant 103 to wet all surfaces under the mount 101 in the thin gap formed between two shingle tabs.

FIGS. 7A-7B depict isometric perpendicular cut-away views of the roof attachment 100 in an assembled state 151 with sealant 103 omitted for illustrative purposes such that a view of the interior of roof attachment 100 may be unobstructed. As shown, a first lock-tab 202 is engaged with an engagement feature 110. The one or more lock-tabs 202 may be shaped to have a lead-in angled, chamfered, or radiused surface in order to readily slide over the side exterior surface of mount 101 to then “click” into a locked position onto the engagement feature 110 on the mount 101. The one or more lock-tabs 202 may have one or more adjacent cut-away apertures 212 in perimeter wall 209 to increase the length of a lock-tab 202 to increasing flexibility. The lock-tabs 202 may have a tapered cross-section. The one or more lock-tabs 202 may be positioned evenly around mount 101 perimeter or offset close to one side of mount 101 perimeter.

FIG. 8A through 8E depict various views of the roof attachment 100 being installed on installation surface 1001, representing an example method of installation. FIGS. 8A-8E also demonstrate the transition of roof attachment 100 from a pre-installed state 152 to an installed state 153 and installation of a rail. In FIG. 8A, roof attachment 100 may be placed on installation surface 1001 in pre-installed state 152. In this state, the protective cover 200 supports mount 101 and sealant 103 above the installation surface 1001 such that sealant 103 does not come into contact with the installation surface 1001. One or more pilot holes, or openings, may be drilled into installation surface 1001, or no pilot holes may be drilled into the installation surface 1001. Because the sealant 103 is not in contact with the installation surface 1001, the roof attachment 100 may be able to be readily slid, moved, drug, rotated, or otherwise positioned into a desired location. As an example, mount fastener aperture 114 and cover fastener aperture 206 may be positioned substantially coincident with a pilot hole in the roof if such a pilot hole exists.

FIG. 8B demonstrates a first roof fastener 104 positioned through a fastener aperture 114 and cover fastener aperture 206. Roof fastener 104 may have a hex head shape, a star or hex shaped interior cavity, and may have no flange, or it may have a flanged head. In the example embodiment, the roof fastener 104 also has a metal and rubber bonded washer located underneath the hex head.

FIG. 8C depicts roof attachment 100 in installed state 153, after the downward force is applied onto mount 101 due to the threads of the roof fastener 104 engaging with the installation surface 1001 to overcome the strength of stop-tabs 204, thereby pushing and traversing mount 101 through the body of the protective cover 200 until mount 101 coincides with the installation surface 1001 or in some embodiments, the topside of the mesh 207. In some example embodiments, the roof fastener 104 engages with an opening in the installation surface 1001, such as a pilot hole, and in other embodiments the roof fastener 104 cuts into and subsequently threadably engages with the installation surface 1001. As mount 101 traverses through the body of the protective cover 200, the volume area defined by the space between mesh 207, underside surface 111 and perimeter wall 209 reduces. Sealant 103 is thus compressed between mount 101, installation surface 1001, and protective cover 200, and is forced to flow onto the installation surface 1001, around the one or more roof fasteners 104, and through mesh 207, if present. As previously described, mesh 207 may be offset from the bottom edge of perimeter wall 209 in order to allow sealant 103 to flow over, around and under mesh 207. In this way, a portion or the entire mesh 207 may not contact installation surface 1001. In some example embodiments, sealant 103 may eject beyond perimeter wall 209 of the protective cover 200, as shown in FIG. 8C, or excess sealant 103 may flow into one or more overflow reservoirs.

The volume and shape of sealant 103 disposed on the mount 101 during the assembly process (e.g., transition from pre-assembled state 150 to assembled state 151) may vary to match the volume of space between mesh 207, underside surface 111 and perimeter wall 209 in the installed state 153. As an example, roof attachment 100 may be configured to have a volume of sealant 103 greater than the volume of space under the mount 101 in the installed state 153 in order to intentionally result in sealant 103 ejecting beyond the perimeter wall 209 of the protective cover 200. FIGS. 8D-8E respectively depict an isometric view and a cut-away view of the installed roof attachment onto which a rail 1102 has been installed.

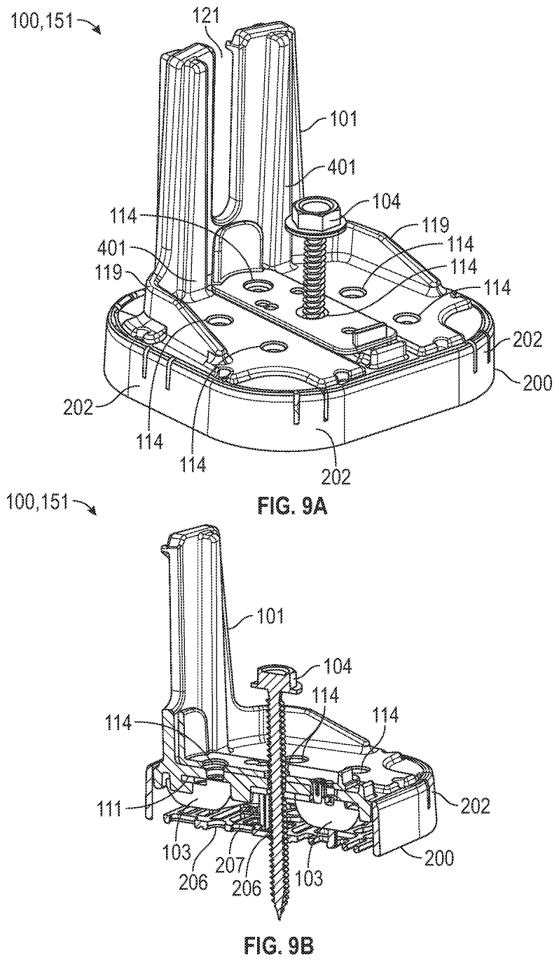

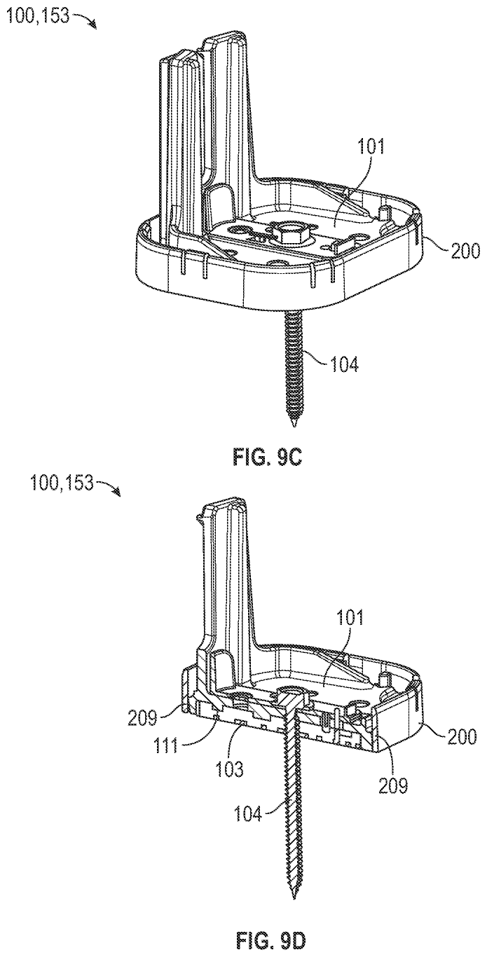

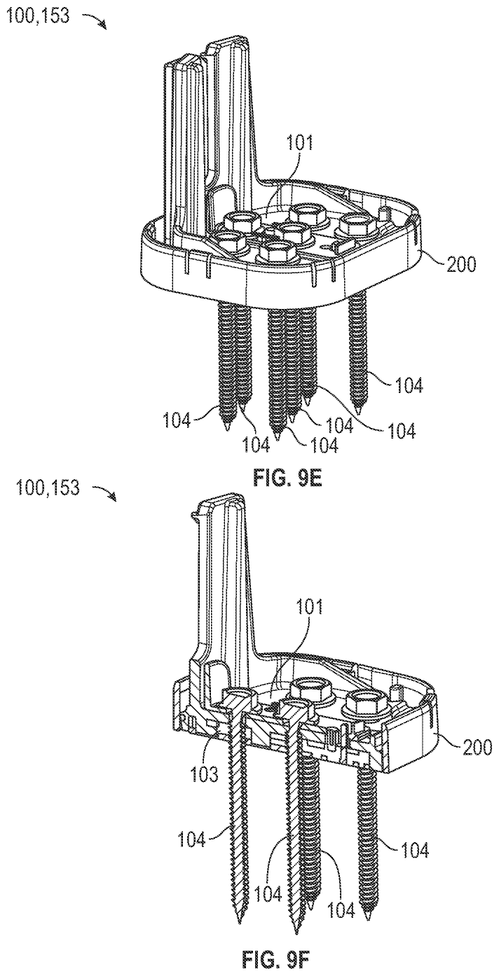

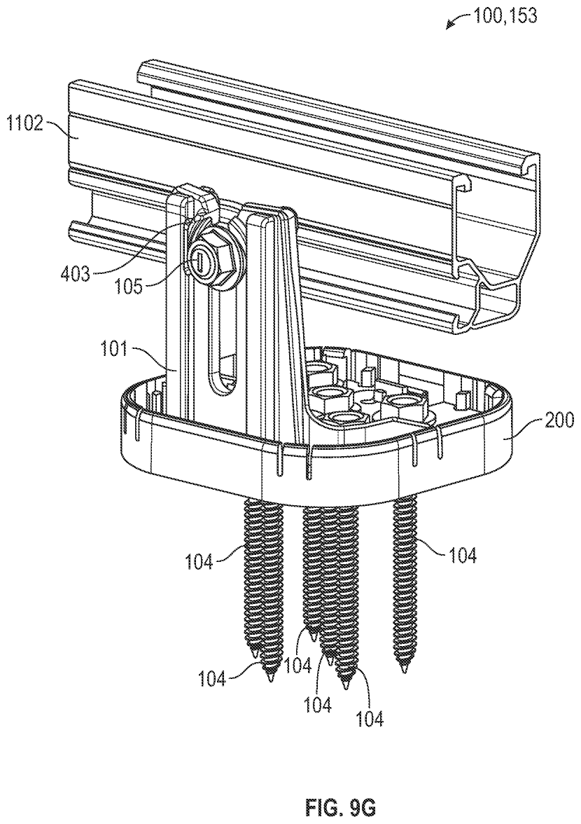

FIGS. 9A-9G depict various views of an alternative embodiment of the roof attachment 100 with mount 101 and protective cover 200 having a plurality of roof fasteners 104, mount fastener apertures 114, and cover fastener apertures 206. FIG. 9A depicts an isometric view of roof attachment 100 in assembled state 151. A first roof fastener 104 is positioned through a first mount fastener aperture 114. FIG. 9B depicts a cut-away view of FIG. 9A, depicting sealant 103 disposed on underside surface 111. Sealant 103 is in a sideways “D” shape, and offset from mesh 207. A plurality of cover fastener apertures 206 are positioned coincidentally respective to a like plurality of mount fastener apertures 114. FIG. 9C and FIG. 9D depict roof attachment 100 in an installed state 153 after a first roof fastener 104 is engaged with an installation surface 1001 (e.g., surface of a roof) to press mount 101 through the body of protective cover 200 until mount 101 contacts installation surface 1001 (omitted for illustrative purpose of showing fastener 104 in engaged position). As shown in the cut-away view in FIG. 9D, sealant 103 has been compressed against underside surface 111 and perimeter wall 209, through mesh 207 and onto roof surface 1001. FIGS. 9E and 9F depict roof attachment 100 in an installed state 153 where additional roof fasteners 104 have been installed through additional mount fastener apertures 114 and into an installation surface 1001. FIG. 9G depicts an isometric view of roof attachment 100 in an installed state 153, with a connection mechanism 105 engaged with mount 101. In this example embodiment, connection mechanism 105 is a nut and bolt fastener, and the connection mechanism 105 secures a rail 1102 to mount 101. Rail 1102 may be used to support one or more solar energy panels. Rail 1102 may be an aluminum extrusion, a steel bar, a bracket, or another suitable configuration. While illustrated and described herein as being used to mount a rail 1102, the roof attachment 100 may also be used to mount to an installation surface one or more other types of appliances, such as a solar panel itself, a clamp for a solar panel, an HVAC unit, electrical conduit, plumbing, dividing walls (e.g., of building structures), staircase, pads, generators, battery enclosures, electrical equipment enclosures, satellite dishes and associated equipment, etc.

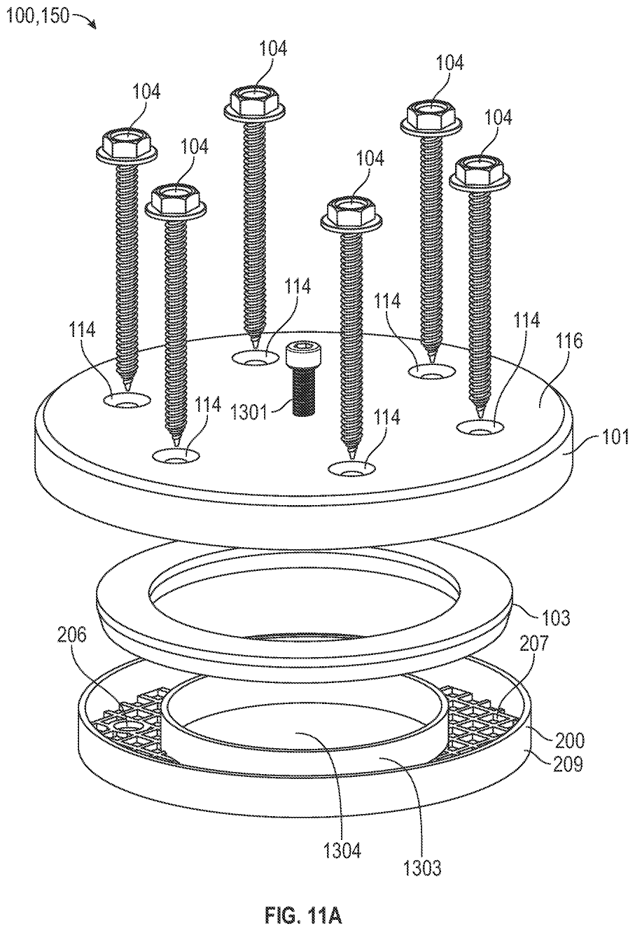

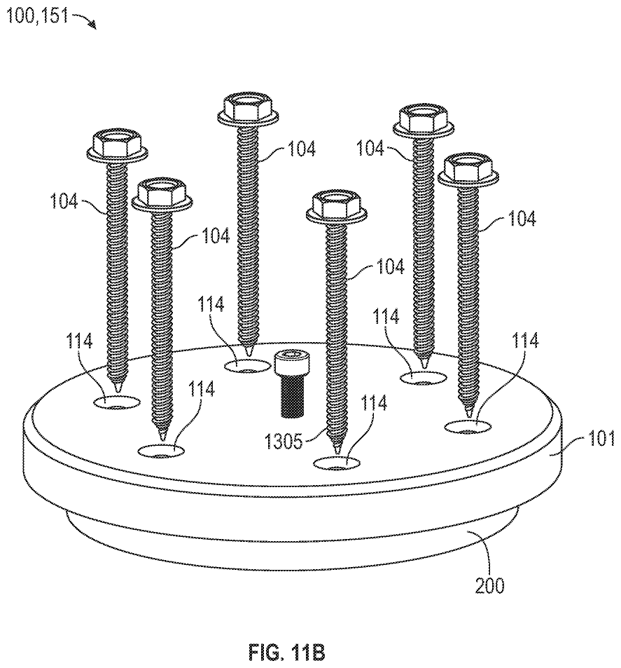

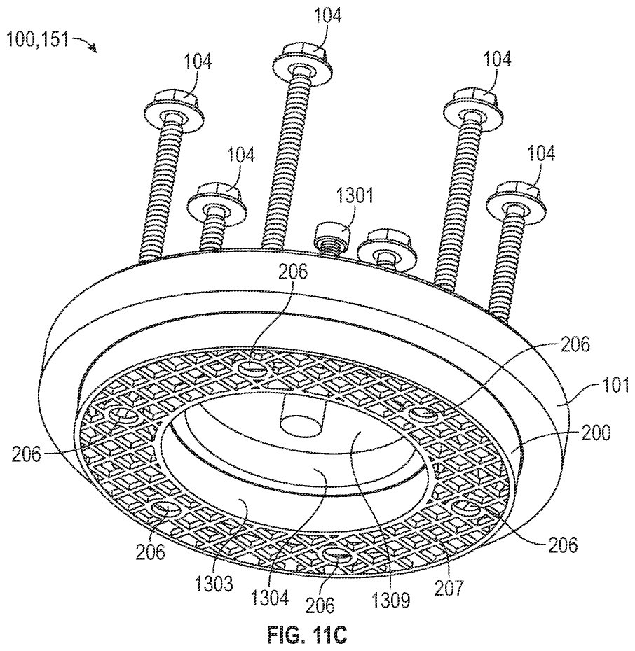

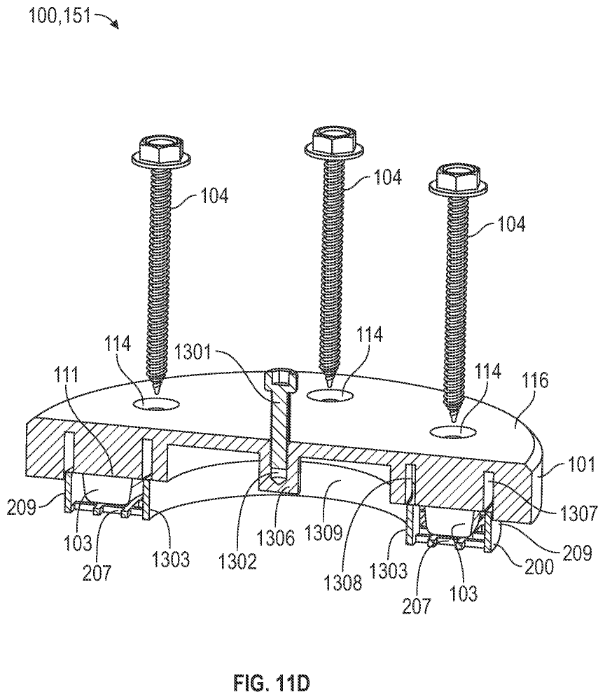

In the example embodiment of mount 101 shown, a vertical flange 118 exists. However, in other example embodiments not shown, mount 101 may have no such vertical flange 118. In other example embodiments not shown of mount 101, mount 101 may have one or more threaded bosses, configured to engage with one or more fasteners for attaching various brackets (e.g. some examples depicted in FIGS. 11A-11D, FIGS. 12A-12C, and FIGS. 17A-17B).

FIG. 10A depicts an isometric view of a roof attachment demonstrating a mount 101 and protective cover 200 with a plurality of mount fastener apertures 114. In the example embodiment, one or more mount fastener apertures 114 are located on one side of the vertical flange 118, and one or more mount fastener apertures are located on the other side of the vertical flange 118, which is parallel with a shorter diameter of the base 117. In another embodiment not shown, the plurality of mount fastener apertures 114 may be located in a circular, oval or similar pattern around the base 117 as viewed from above. FIG. 10B depicts an isometric view of an alternative embodiment of the present invention demonstrating a mount 101 and protective cover 200 with a plurality of mount fastener apertures 114, and with an alternative configuration in which the vertical flange 118 is parallel with the longer diameter of the base 117.

FIGS. 11A-11D depict various views of an alternative example of the present invention where mount 101 has no vertical flange 118. In this example, a plurality of mount fastener apertures 114 may be disposed across mount 101, such as in an evenly spaced circular pattern as shown. Mount fastener apertures 114 may have a chamfer, radius, or sloped edge transitioning between the top surface 116 and the inside of a given mount fastener aperture 114. Mount 101 may be a circular shape as shown, with one or more accessory fasteners 1301 threadably engaged to an accessory aperture 1302 (illustrated in FIG. 11D) disposed on top surface 116 for securing various accessory components, such as an HVAC bracket, L-foot, solar energy mounting system, or other equipment typically installed on a building rooftop. Top surface 116 may be substantially flat as shown, or may have one or more protrusions, bosses, flanges, platforms, or similar features that one or more accessory apertures 1302 may be disposed into.

Protective cover 200 may be substantially similar in shape to mount 101, such as a circular shape as shown. In this example embodiment, protective cover 200 also has an interior wall 1303 that forms a central cover opening 1304. Mesh 207 is disposed between perimeter wall 209 and interior wall 1303 and may not extend across the central cover opening 1304, as shown. One or more cover fastener apertures 206 may be disposed throughout the mesh 207 and arranged to substantially align with a respective one or more mount fastener apertures 114. Protective cover 200 may not have lock-tabs 202 as shown. In other examples not shown, one or more lock-tabs 202 and stop-tabs 204 may be disposed along either or both perimeter wall 209 or interior wall 1303. Sealant 103 may be disposed onto mount 101 or in the protective cover 200 in a shape where sealant 103 is between perimeter wall 209 and interior wall 1303.

Roof fastener 104 may have a hex head as shown, which may be configured to engage with a ½″ socket or a 13 mm socket. Roof fastener 104 may have a flange under the hex head which may have serrations disposed on the underside. Roof fastener 104 may have a cutting tip 1305 configured to cut into the installation surface 1001 in order to avoid pre-drilling a pilot hole. Accessory fastener 1301 may have a different head type, such as a socket hex head as shown, or it may have the same hex head as on the roof fastener 104 in order to allow for the same tool to engage both the roof fastener 104 and the accessory fastener 1301.

FIG. 11B depicts roof attachment 100 in assembled state 151, including the accessory fastener 1301 partially installed into mount 101. In other example embodiments of this style of roof attachment 100 in an assembled state 151, accessory fastener 1301 may not be installed. FIG. 11C depicts an underside view of roof attachment 100 in assembled state 151.

FIG. 11D depicts roof attachment 100 in assembled state 151 in a cut-away view in order to better depict the inside functions of the present invention. As depicted, sealant 103 is disposed onto the underside surface 111 such that sealant 103 is between perimeter wall 209 and interior wall 1303. Perimeter wall 209 may align with perimeter wall groove 1307, and interior wall 1303 may align with interior wall groove 1308 such that mount 101 can traverse down and through the body of protective over until contacting the installation surface 1001. In other example embodiments, perimeter wall 209 may be positioned outer to mount 101 (such as in FIG. 1), and interior wall 1303 may be positioned inside a central mount cavity 1309. Thread boss 1306 may extend into central mount cavity 1309 to provide sufficient depth of the accessory aperture 1302 for a accessory fastener 1301 to fully seat onto the top surface 116. Accessory aperture 1302 may be enclosed, or captured, or blind on the end, such that the accessory aperture 1302 does not extend or open to the central mount cavity 1309.

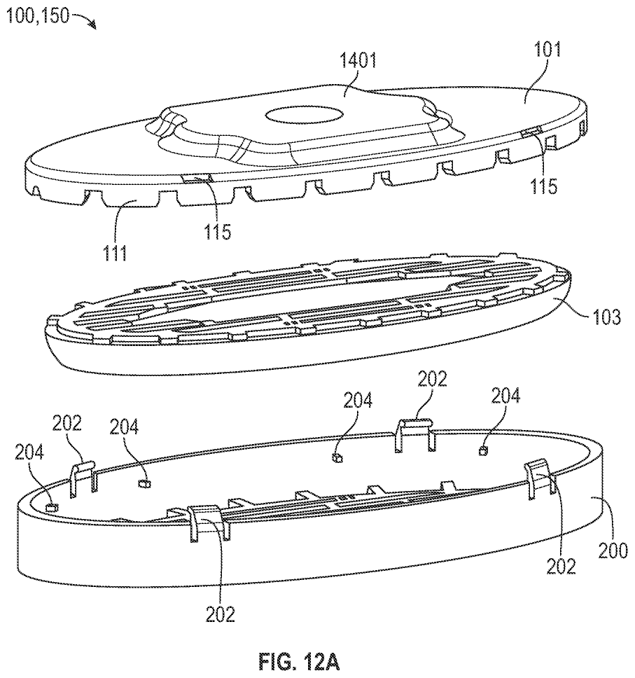

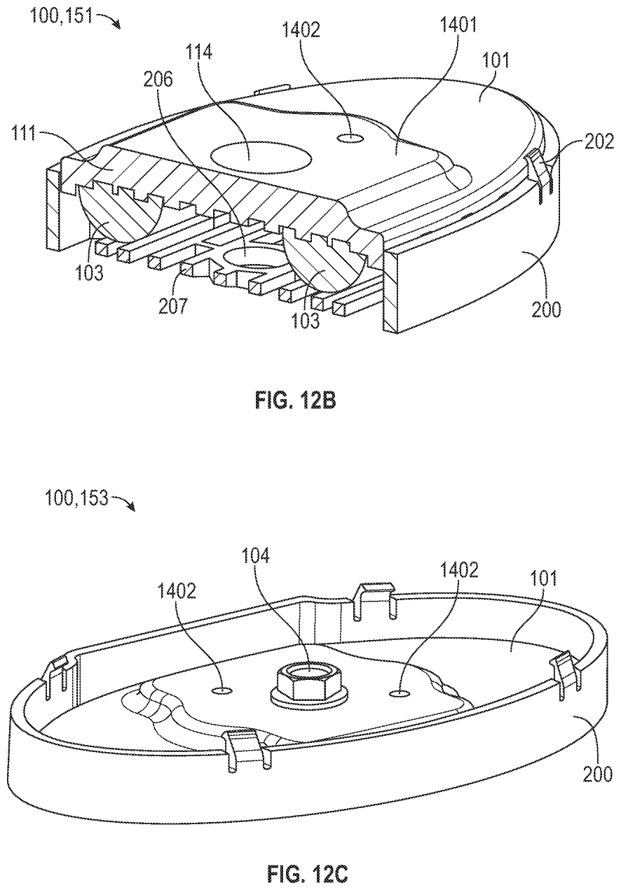

FIG. 12A-12C depict various views of the present invention where mount 101 has no vertical flange 118. In this example embodiment of the present invention, base 117 has a one or more mount fastener apertures 114 configured on a mounting platform 1401 on base 117. Mounting platform 1401 may be configured to support various accessories, such as an L-shaped bracket, a conduit support strap, a plumbing strap, an attachment bracket or pipe for HVAC units, or numerous other applications. One or more accessory apertures 1402 may be disposed on mounting platform 1401 and configured to receive and engage with a threaded fastener. Accessory apertures 1402 may be threaded, and may or may not cut through to the underside surface 111. In this example configuration, mount 101 may be formed out of sheet metal, extruded metal, stamped metal, die cast metal, injection molded plastic, or similar process and materials. In another example embodiment not shown, a clasp, ratchet, strap, or similar retention feature may be formed from base 117 to secure one or more pipes or tubes, such as electrical conduit. FIG. 12C depicts an isometric view of the present invention with roof attachment 100 in an installed state 153 with a roof fastener 104 installed. In some example embodiments not shown, mounting platform 1401 may be taller than the top of the protective cover when the roof attachment 100 is in an installed state 153.

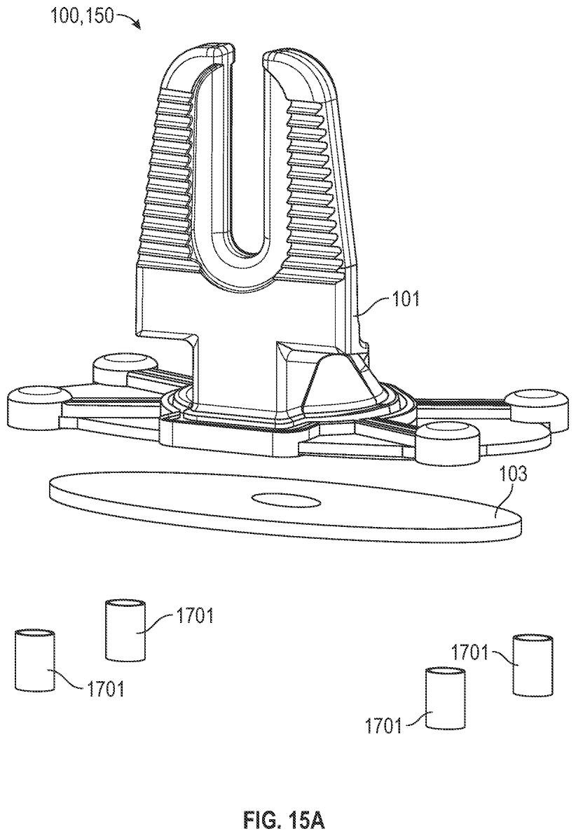

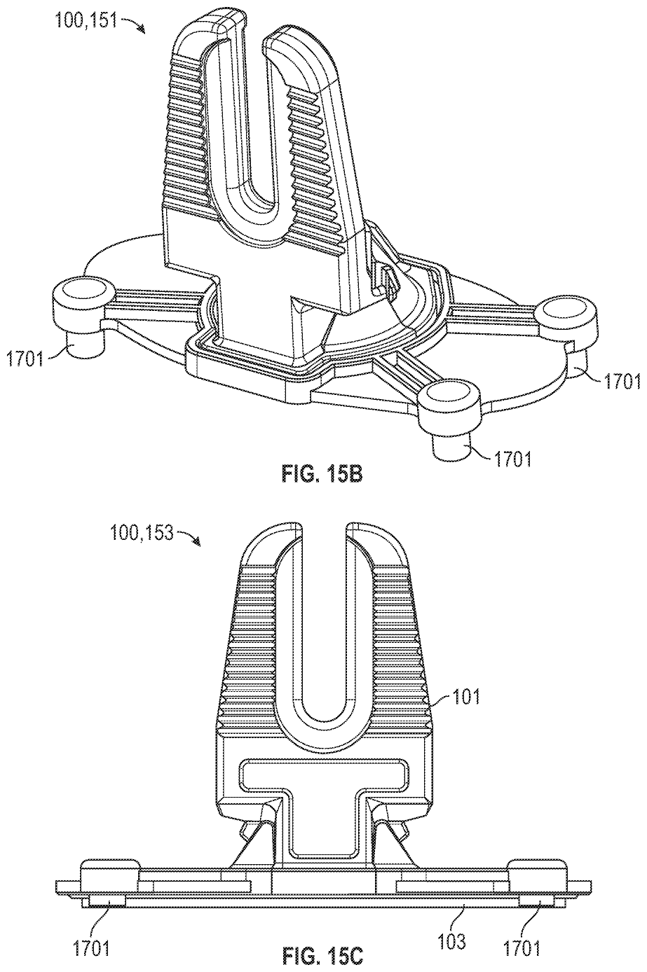

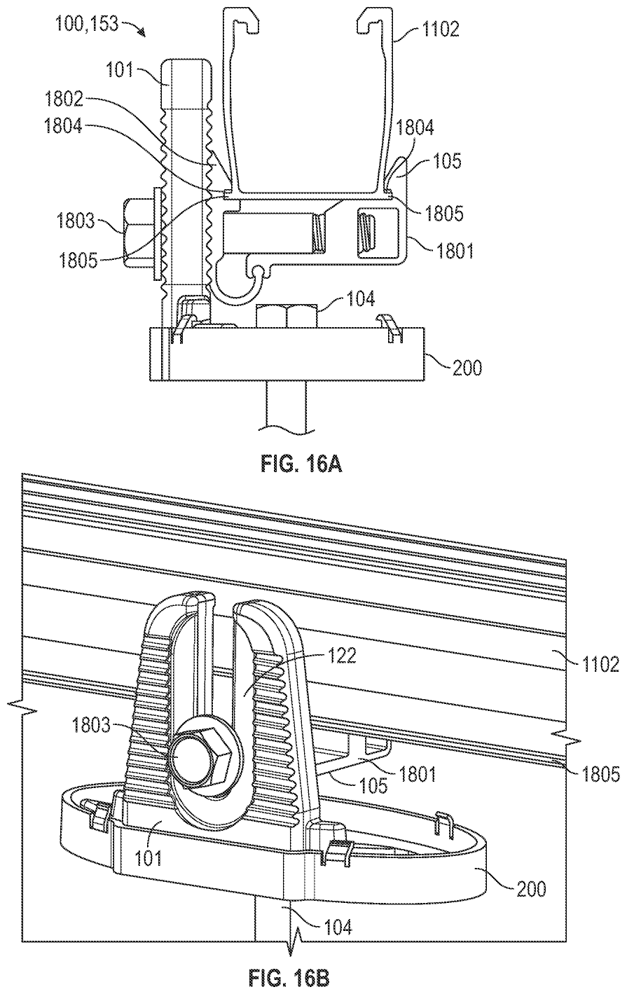

FIGS. 13A-13C are various views showing a different example embodiment of the present invention. In this example embodiment, the protective cover 200 consists of a perimeter wall 209 with a single large opening 1501 (without ribs 208 or mesh 207 across the bottom surface as shown in FIGS. 2A-2C). Protective cover 200 may have a groove 1502 around the interior upper portion configured to grip onto the outer perimeter of base 117 in order to secure protective cover 200 in the assembled state 151 illustrated in FIG. 15B. In this example embodiment, protective cover 200 may be made from a resilient flexible material, such as a rubber, silicon, foam, plastic, or other suitable material. As viewed in a cross section in FIG. 13C, protective cover 200 may have a tapered shape such that the lower portion of perimeter wall 209 is farther from the central portion of the roof attachment 100 than the upper portion. In other words, the lower distal end of perimeter wall 209 has a larger circumference than the upper distal end. In an alternative embodiment not shown, sealant 103 may have a substantially uniform thickness and may cover the majority of the open underside of mount 101 surrounded by perimeter wall 209. In this alternative embodiment, sealant 103 may be a butyl tape, butyl mastic, PVC, or other similar material.

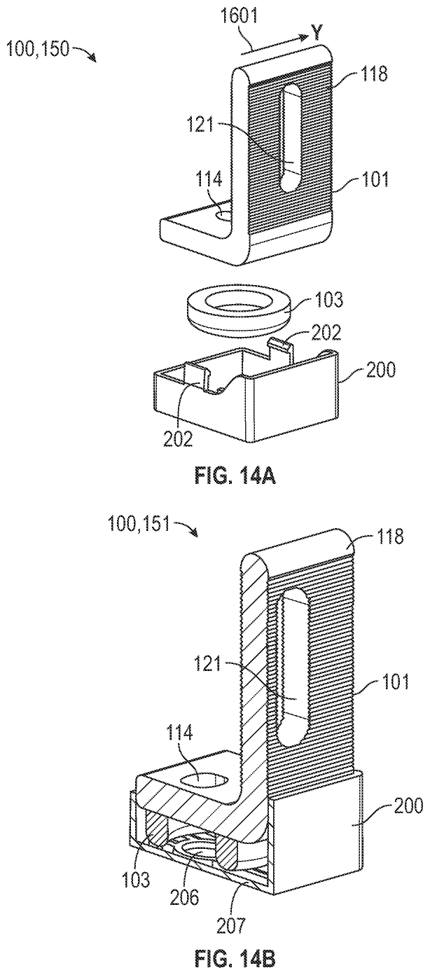

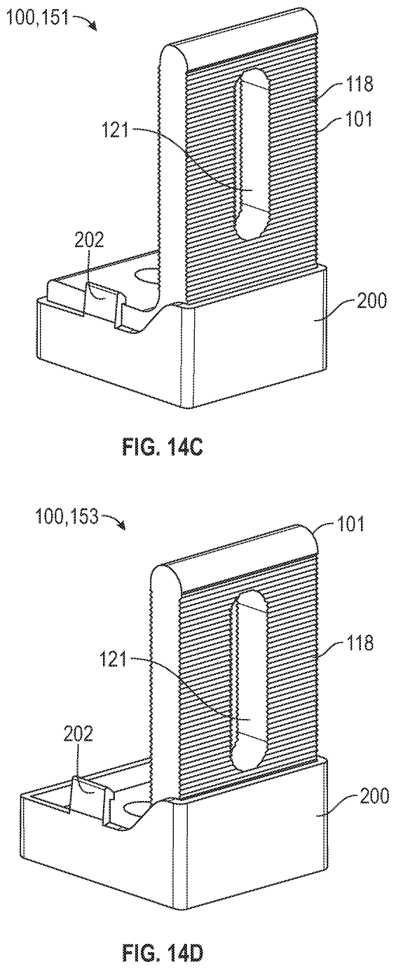

FIGS. 14A-14D depict another alternative embodiment of the present invention. In this example embodiment, mount 101 has a cross-section that is the same shape along its entire length in the Y-direction 1601, except for one or more mount fastener apertures 114 and/or one or more flange aperture 121 disposed orthogonal to the cross-section. Mount 101 in this example embodiment may be made from an extrusion, casting, machining, forging, roll forming, bending, stamping or other suitable process, and may be made from aluminum, steel, stainless steel, plastic, a synthetic polymer, or other suitable material. Functioning the same as in roof attachment 100 previously described, a volume of sealant 103 may be disposed on the underside of the mount 101, and protective cover 200 may be secured onto mount 101 with one or more lock-tabs 202 and stop-tabs 204 as previously described. Flange aperture 121 in this example embodiment of mount 101 may be a closed slot, as shown, or may be an open slot with the top end of the slot open to the top of mount 101 such that a fastener could traverse down the slot from the top of mount 101.

FIGS. 15A-15C depict an alternative embodiment of the present invention in which protective cover 200 is replaced with one or more flexible resilient feet 1701. Sealant 103 may be similar in shape and cross-section as described in earlier embodiments or may be a uniformly thick plane as shown. In the same installation method described previously, roof attachment 100 may be placed on a installation surface 1001 with one or more flexible resilient feet 1701 supporting roof attachment 100 at a desired height above the installation surface 1001 such that the sealant 103 does not contact the installation surface 1001 in a pre-installed state 152. In other words, flexible resilient feet 1701 have a height below the bottom of mount 101 greater than the thickness of the sealant 103 and have a resiliency greater than the weight of the roof attachment 100 to as not to compress and thereby maintain the sealant 103 from becoming equal to or reaching the bottom surface of the flexible resilient feet 1701 prior to installation to an installation surface 1001. Upon one or more roof fasteners 104 being installed through one or more mount fastener apertures 114, a downward force exerted from the mount fastener 104 engaging with an installation surface 1001 would compress the one or more flexible resilient feet 1701 until sealant 103 contacts installation surface 1001 in installed state 153 as shown in FIG. 15C. In addition, mount 101 may have one or more perimeter feet 124, not shown but similar to those described in FIGS. 3A-3C, that coincide with the installation surface 1001 when mount 101 is fully installed. In this way, the roof attachment 100 has transitioned from a pre-installed state 152 to an installed state 153.

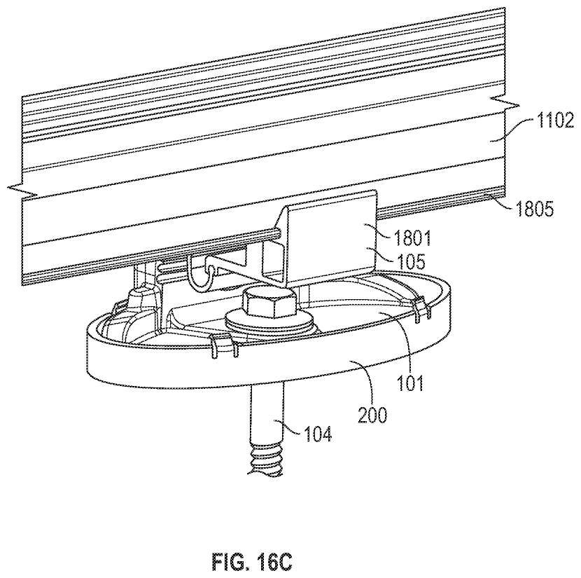

FIGS. 16A-16C depict various views of the present invention demonstrating an alternative connecting mechanism 105 to secure a rail 1102 to mount 101 of roof attachment 100. In this example embodiment, the connecting mechanism 105 may consist of one or more grip pieces 1801 and 1802 with a grip fastener 1803. The grip pieces 1801 and 1802 may be formed from a single piece, or may be two separate pieces as shown. The one or more grip pieces 1801 and 1802 may have one or more grooves 1804 that secure onto rail flanges 1805. Grip fastener 1803 may have a flanged hex head, a simple hex head, or a socket hex head. Grip fastener 1803 may threadably engage and compress the one or more grip pieces 1801 and or 1802 onto the rail 1102 and connecting mechanism 105 to vertical flange 118. In an example embodiment of the present invention where the grip fastener 1803 has a flanged head, the flange may seat in a rear recess 122. In the example embodiments shown, rail 1102 may be secured to roof attachment 100 after the roof attachment 100 is in an installed state 153.

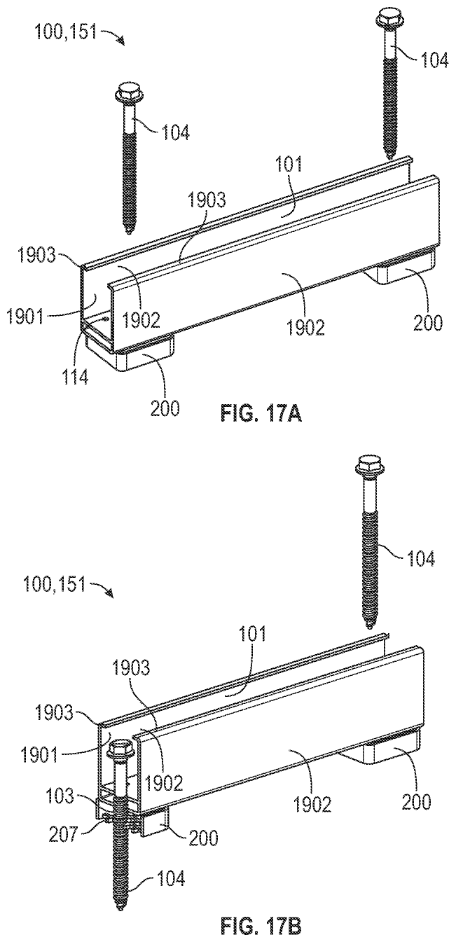

FIGS. 17A and 17B depict an isometric view and an isometric cut-away view of an alternative embodiment of the present invention where a channel 1901 is disposed along the length of mount 101. In this example embodiment, a channel 1901 is formed from two side walls 1902. Lateral protrusions 1903 may extend inwards to the channel 1901 as shown, or may extend exterior to the channel. In this example embodiment, mount 101 may have a uniform cross section along its entire length, except for one or more apertures, such as a mount fastener aperture 114. Channel walls (e.g., side walls 1902) may be parallel with one another, or may be at an obtuse or acute angle relative to one another.

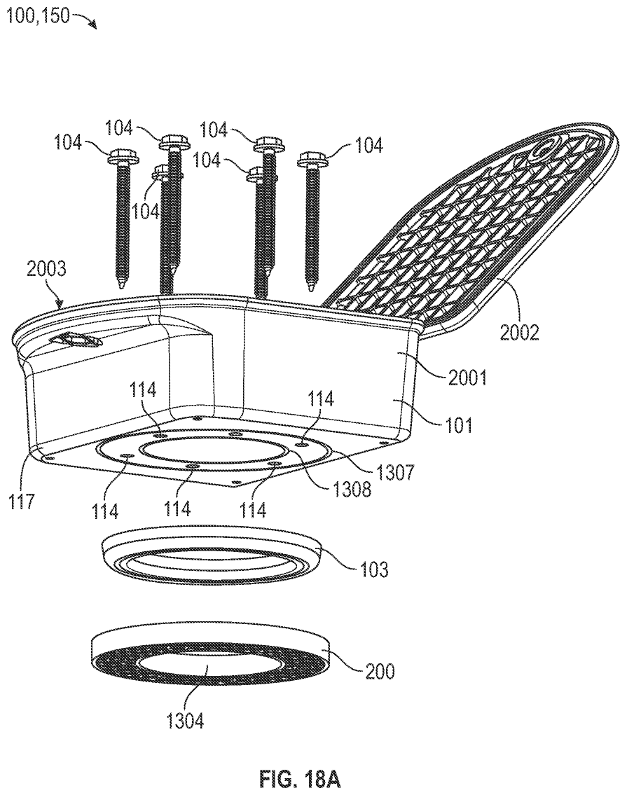

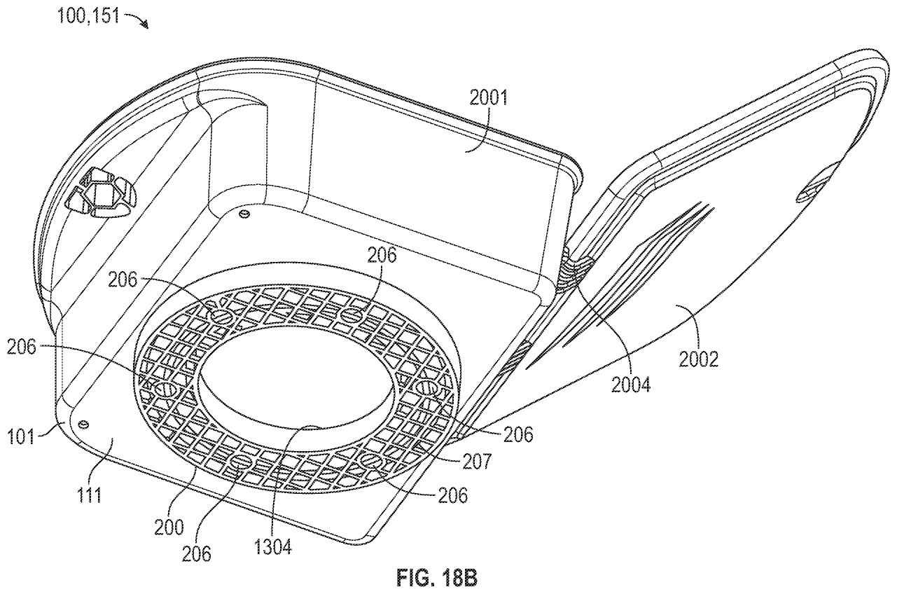

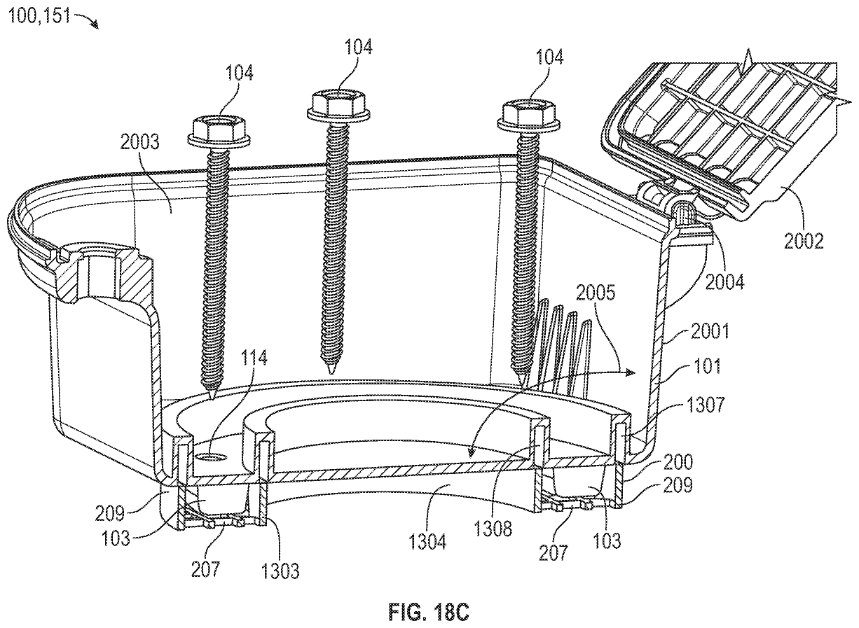

FIGS. 18A-18C depict various views of an alternative example of the present invention where mount 101 is configured as an enclosable container. In FIG. 18A, mount 101 has side walls 2001 that extend up from base 117, which may form a box configuration. Base 117 may be a square, rectangular, or polygonal shape with side walls 2001 extending up from all edges to form an upper inside cavity 2003. A lid 2002 may be releasably connected via a hinge 2004 to one of the side walls 2001, and configured to secure to a side wall 2001 opposite or adjacent to hinge 2004. One or more roof fasteners 104 may be used to secure the roof attachment 100 to an installation surface 1001. One or more mount fastener apertures 114 may be disposed on base 117. FIG. 20A depicts an exploded view of the roof attachment 100 in an unassembled state 150, where sealant 103 and protective cover 200 are not yet assembled onto mount 101.

FIG. 18B depicts an underside view of roof attachment 100 in an assembled state 151, where sealant 103 has been disposed on the underside surface of mount 101, and protective cover 200 has been installed to mount 101 using one or more lock-tabs 202 engaging with one or more respective engagement features, not shown. One or more cover fastener apertures 206 may be disposed in mesh 207 and substantially aligned with a respective one or more mount fastener apertures 114 when protective cover 200 is assembled onto mount 101. Central cover opening 1304 may be configured to be large enough for one or more conduit apertures (not shown) to be disposed through underside surface 111 and within the central cover opening 1304. The one or more conduit apertures may be formed after roof attachment 100 is in an assembled state 151 or even after an installed state 153. Not shown, one or more perimeter feet 124 and mount feet 112 may be disposed across the underside surface 111.

FIG. 18C depicts a cut-away view of roof attachment 100 in assembled state 151. In this example embodiment, mount 101 may be made from a polymer, plastic, metal, or similar material. Side walls 2001 may be formed at an obtuse angle 2005 relative to base 117. Perimeter wall 209 may be configured to slide into a perimeter wall groove 1307, and interior wall 1303 may align with interior wall groove 1308 such that mount 101 can traverse down and through the body of protective cover 200 until contacting the installation surface 1001. Not shown, one or more bosses or protrusions may extend up from the bottom inside surface and may be configured with a cut-out or aperture configured to receive a screw for securing electrical equipment, such as a DIN rail or electrical terminal block.

In an example installation method, roof attachment 100 may be in an assembled state 151 and placed onto an installation surface 1001. One or more roof fasteners 104 may be inserted through a mount fastener aperture 114 and cover fastener aperture 206 and threadably engaged into the installation surface 1001. Upon a roof fastener 104 head engaging with the installation surface 1001, mount 101 is pulled towards the installation surface 1001 with sufficient force to overcome the strength of one or more stop-tabs 204 (not shown). The mount 101 being pulled toward the installation surface 1001 would compress sealant 103 through one or more openings in mesh 207 and onto the installation surface 1001. Additional roof fasteners 104 may be installed after a first fastener 104 is installed. One or more conduit apertures may be formed into the base 117, e.g., into the bottom surface of the upper inside cavity 2003 and through an installation surface 1001, and configured to allow one or more electrical wires to pass through.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A roof attachment apparatus comprising:
a mount;
a fastener configured to engage with an installation surface, wherein the fastener attaches the mount to the installation surface when engaged with the installation surface; and
a compressible sealant disposed between a bottom of the mount and the installation surface when the mount is attached to the installation surface, wherein the sealant is compressed based on the engagement between the fastener and the installation surface, the compressed sealant flowing to fill a volume of space between the bottom of the mount and the installation surface.

2. The apparatus of claim 1, wherein the installation surface includes one or more openings, the fastener engaging with an opening in the installation surface, and wherein the volume of space filled by the sealant includes space associated with other openings in the installation surface.

3. The apparatus of claim 1, further comprising a protective cover that includes one or more openings, and wherein the compressed sealant flows through one or more openings of the protective cover onto the installation surface.

4. The apparatus of claim 3, wherein the protective cover further includes one or more apertures, wherein the fastener passes through the apertures of the protective cover.

5. The apparatus of claim 3, wherein the protective cover is configured to prevent the sealant from contacting the installation surface until the sealant is compressed.

6. The apparatus of claim 3, wherein the protective cover includes one or more stop-tabs configured to support the mount and to prevent the mount from traversing relative to the protective cover based on a resilience of the stop-tabs.

7. The apparatus of claim 6, wherein the fastener engages with the installation surface at different stages of engagement, wherein at least one stage of engagement imparts a force that overcomes the resilience of the stop-tabs.

8. The apparatus of claim 3, wherein the protective cover includes one or more lock-tabs configured to secure the protective cover to the mount.

9. The apparatus of claim 1, wherein a force greater than a weight of the mount is required to compress the sealant to contact the installation surface.

10. The apparatus of claim 1, wherein the sealant includes a petroleum-based compound.

11. The apparatus of claim 10, wherein the petroleum-based compound is a butyl-based compound.

12. The apparatus of claim 1, wherein the sealant retains a liquid state associated with flowability for a period of time after being compressed between the mount and the installation surface.

13. The apparatus of claim 12, wherein the period of time is at least 180 days.

14. The apparatus of claim 1, wherein the mount includes a vertical flange with an aperture disposed therethrough.

15. The apparatus of claim 1, wherein the mount includes a fastener aperture disposed on a top surface, the fastener aperture configured to engage with the fastener.

16. A roof attachment apparatus comprising:
a mount;
a protective cover having a bottom surface with one or more openings therein; and
a quantity of sealant disposed between the mount and the protective cover, wherein the protective cover prevents the sealant from contacting an installation surface until the sealant is compressed between the mount and the protective cover, wherein when the sealant is compressed by a force greater than a weight of the mount, the sealant flows through the one or more openings of the bottom surface of the protective cover onto the installation surface to substantially fill a volume of space between the bottom surface and the installation surface.

17. The apparatus of claim 16, further comprising:
a rail; and
a connection mechanism that secures the rail to the mount.

18. The apparatus of claim 16, wherein the installation surface is an asphalt shingle roof.

19. A method of installing a roof attachment, the method comprising:
placing a roof attachment onto an installation surface, wherein the roof attachment is positioned such that a sealant is disposed between a bottom surface of the roof attachment and the installation surface;
installing a fastener that engages with an installation surface, wherein the fastener attaches the roof attachment to the installation surface when engaged with the installation surface; and
imparting a force based on the engagement between the fastener and the installation surface, wherein the force compresses the sealant onto the installation surface, and wherein the compressed sealant occupies a volume of space between the installation surface and the roof attachment.

20. The method of claim 19, wherein the roof attachment further includes a mount, a protective cover, and one or more stop-tabs that prevent traversal of the mount through the protective cover before the force is imparted, wherein the force imparted by the engagement further overcomes a strength of the stop-tabs and results in the mount traversing through the protective cover.

21. The method of claim 19, further comprising attaching a rail to the roof attachment using a connection mechanism.

22. A method of assembling a roof attachment, the method comprising:
robotically disposing a volume of sealant on an underside surface of a mount; and
securing a protective cover onto the mount using one or more lock-tabs, wherein the sealant does not protrude beyond an opening in the protective cover.

23. A roof attachment apparatus comprising:
a mount;
one or more resilient flexible members configured to support the mount above an installation surface; and
a sealant disposed on an underside of the mount, wherein the resilient flexible members extend below a bottom surface of the sealant and prevent the sealant from touching the installation surface under a force of gravity, and wherein when a fastener is engaged with the installation surface, the fastener imparts a force that compresses the resilient flexible members until the sealant is in contact with the installation surface.

24. The apparatus of claim 23, wherein the sealant includes a butyl-based tape.

25. A roof attachment apparatus comprising:
a mount that includes a plurality of walls that form a box;
a protective cover; and
a sealant disposed between a bottom of the mount and an installation surface, wherein the sealant is compressed based on an engagement between a fastener and the installation surface, the compressed sealant flowing to fill a volume of space between the bottom of the mount and the installation surface.

26. The apparatus of claim 25, wherein one or more stop-tabs disposed on the protective cover prevent traversal of the mount relative to the protective cover before the force is imparted, wherein the force imparted by the engagement further overcomes a strength of the stop-tabs and results in the mount traversing relative to the protective cover.
